(19) United States
(12) Patent Application Publication
(10) Pub. No.: US 2025/0261121 A1
(43) Pub. Date: Aug. 14, 2025

(54) INFORMATION DETERMINING METHOD AND COMMUNICATION DEVICE

(71) Applicant: VIVO MOBILE COMMUNICATION CO., LTD., Guangdong (CN)

(72) Inventor: Xiaowan KE, Guangdong (CN)

(73) Assignee: VIVO MOBILE COMMUNICATION CO., LTD., Guangdong (CN)

(21) Appl. No.: 19/194,462

(22) Filed: Apr. 30, 2025

Related U.S. Application Data
(63) Continuation of application No. PCT/CN2023/127465, filed on Oct. 30, 2023.

(30) Foreign Application Priority Data
Nov. 3, 2022 (CN) 202211373029.5

(51) Int. Cl. H04W 52/02; H04L 49/9023; H04W 76/10

(52) U.S. Cl. CPC H04W 52/0248; H04L 49/9023; H04W 76/10

(57) ABSTRACT

Embodiments of this application provide an information determining method and a communication device, pertaining to the field of wireless communications technologies and including: performing, by a first communication device, a first operation; where the performing a first operation includes at least one of the following: obtaining first information, where the first information includes at least one of the following: a first timestamp of a target data packet, a sampling frequency, information for identifying the target data packet, and information for identifying a target burst to which the target data packet belongs; performing a first sub-operation of the first operation based on the first information; and performing a second sub-operation of the first operation.

### CROSS-REFERENCE TO RELATED APPLICATIONS

This application is a continuation application of International Application No. PCT/CN2023/127465, filed on Oct. 30, 2023. International Application No. PCT/CN2023/127465 claims priority to Chinese Patent Application No. 202211373029.5, filed on Nov. 3, 2022. Each of the above-listed applications is incorporated herein by reference in its entirety.

### TECHNICAL FIELD

Embodiments of this application pertains to the field of wireless communications technologies, and in particular, relates to an information determining method and a communication device.

### BACKGROUND

In wireless communication networks, transmission of extended reality (XR) services is periodic, and data transmission is mainly performed at the beginning of a periodicity. For example, 10 ms is a periodicity, the first 3 ms is for data transmission, and the remaining 7 ms has no data transmission, so that a terminal may sleep in a no data transmission interval, which makes the terminal energy-saving. How to support determining of a data transmission interval and/or a no data transmission interval to make the terminal energy-saving is a technical problem to be urgently resolved.

### SUMMARY

According to a first aspect, an embodiment of this application provides an information determining method, including:
performing, by a first communication device, a first operation.

The performing a first operation includes at least one of the following:
obtaining first information, where the first information includes at least one of the following: a first timestamp of a target data packet, a sampling frequency, information for identifying the target data packet, and information for identifying a target burst to which the target data packet belongs;
performing a first sub-operation of the first operation based on the first information; and
performing a second sub-operation of the first operation;
where
the second sub-operation of the first operation includes at least one of the following:
determining a third time;
assigning, to a target data packet, information for identifying the target data packet;
assigning, to a target burst, information for identifying the target burst;
enabling a first header of the target data packet to include at least one of the following: information for identifying the target data packet and information for identifying the target burst to which the target data packet belongs;
enabling a first header of the 1st data packet in the target burst to include a start indication of the target burst;
enabling a first header of the last data packet in the target burst to include an end indication of the target burst;
determining a first delay, where the first delay is one of the following: a required delay or time for a target data packet to pass between a first source end and a second communication device (such as a radio access network (RAN) network element), a time difference between a sampling time of the 1st byte of the target data packet and a time at which the target data packet arrives at the second communication device (such as the RAN network element), and a time difference between the sampling time of the 1st byte of the target data packet and a time at which the target data packet arrives at the first communication device (such as a time of arriving at an access stratum (AS) or non-access stratum (NAS) of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first sub-operation of the first operation includes at least one of the following:
enabling the first header of the target data packet to include at least one of the following: information for identifying the target data packet (such as a sequence number of the target data packet), information for identifying the target burst to which the target data packet belongs (such as a sequence number of the target burst), the first timestamp, and a first time;
determining a time corresponding to the first timestamp;
sending the first timestamp or the time corresponding to the first timestamp as the first time;
sending the target data packet to a first target end;
sending assistance information to the first target end, where the assistance information includes at least one of the following: the first information, third information, fifth information, and seventh information; and
receiving a first data packet after the target data packet is sent to the first target end, where a first header of the first data packet includes one of the following: information for identifying the target data packet, the first timestamp, the first time, and a second time.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs; and
the first source end is a data source end of the target data packet;
where
the first time is in a form of a time of sending the target data packet by the first communication device;
the second time is a time at which the target data packet arrives at the second communication device or the RAN network element; and
the third time is a time at which the target data packet arrives at the first communication device.

According to a second aspect, an embodiment of this application provides an information determining method, including:
obtaining, by a second communication device, eighth information, where the eighth information includes at least one of the following: a first timestamp of a target data packet, a sampling frequency, information for identifying the target data packet, information for identifying a target burst to which the target data packet belongs, a second time of the target data packet, and a third time of the target data packet; and
performing a second operation based on the eighth information.

The second operation includes at least one of the following:
determining a time corresponding to the first timestamp;
determining a first delay, where the first delay is one of the following: a required delay for a target data packet to pass between the first source end and a radio access network RAN network element, a time difference between a sampling time of the 1st byte of the target data packet and a time at which the target data packet arrives at a second communication device (such as a RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first timestamp is used to indicate one of the following: a packet sending time of the target data packet sent by the first source end and the sampling time of the 1st byte of the target data packet; and/or the first timestamp is a timestamp in a first header of the target data packet or a first timestamp in a form of a first time;
the first source end is a data source end of the target data packet;
the second time is a time at which the target data packet arrives at the second communication device or the RAN network element; and
the third time is one of the following: a time at which the target data packet arrives at the first communication device (for example, the AS or NAS of the terminal).

According to a third aspect, an embodiment of this application provides an information determining method, including:
performing, by a third communication device, a third operation.

The performing a third operation includes at least one of the following:
performing a first sub-operation of the third operation, including at least one of the following: configuring a first monitoring configuration; configuring a second monitoring configuration; configuring first assistance information; configuring second assistance information; configuring a first requirement; sending at least one of the following to a third target end: the first monitoring configuration, the first requirement, and the first assistance information; and sending one of the following to a fourth target end: the second monitoring configuration and the second assistance information;
receiving at least one of first jitter information, third information, fifth information, and seventh information;
sending at least one of the first jitter information, the third information, the fifth information, and the seventh information;
determining the first jitter information based on the fifth information; and
determining at least one of the following based on the third information: a data packet transmission time interval, a data periodicity, a target burst to which the target data packet belongs, a boundary of the target burst, and a first feature;
where
the first monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
the second monitoring configuration is used for requesting to monitor a second delay, and the second delay is a delay (for example, a downlink delay) between an anchor user plane function (UPF) network element and a RAN network element; or, the second monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter; and
the first assistance information includes at least one of the following: a sampling frequency, a first feature, a data periodicity, a first time interval threshold, a second time interval threshold, and a third time interval threshold;
the second assistance information includes at least one of the following: a sampling frequency, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay;
the first requirement is used for requesting to send a first timestamp to a second communication device;
the first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element; and
the third time is a time at which the target data packet arrives at a first communication device;
where
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range;
where
the seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

According to a fourth aspect, an embodiment of this application provides an information determining method, including:
performing, by a fourth communication device, a fourth operation.

The fourth operation includes at least one of the following:
performing a first sub-operation of the fourth operation;
sending at least one of the following to a fourth target end: a first monitoring requirement, a second requirement, and third assistance information;
receiving at least one of first jitter information, third information, fifth information, and seventh information;
determining the first jitter information based on the fifth information; and
determining at least one of the following based on the third information: a data packet transmission time interval, a data periodicity, a target burst to which the target data packet belongs, a boundary of the target burst, and a first feature.

The first sub-operation of the fourth operation includes at least one of the following:
configuring a first monitoring requirement, where the first monitoring requirement is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
configuring third assistance information, where the third assistance information includes at least one of the following: a sampling frequency, a first feature, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay; and
configuring a second requirement, where the second requirement is used for requesting to send a first timestamp to a second communication device.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element;
the third time is a time at which the target data packet arrives at a first communication device;
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst;
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

The seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

According to a fifth aspect, an embodiment of this application provides an information determining method, including:
performing, by a fifth communication device, a fifth operation.

The fifth operation includes at least one of the following:
sending ninth information, where the ninth information includes at least one of the following:
a sampling frequency;
a first feature;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

According to a sixth aspect, an embodiment of this application provides a communication device, and the communication device is a first communication device, including:
a first execution module, configured to perform a first operation, where
the performing a first operation includes at least one of the following:
obtaining first information, where the first information includes at least one of the following: a first timestamp of a target data packet, a sampling frequency, information for identifying the target data packet, and information for identifying a target burst to which the target data packet belongs;
performing a first sub-operation of the first operation based on the first information; and
performing a second sub-operation of the first operation;
where
the second sub-operation of the first operation includes at least one of the following:
determining a third time;
assigning, to a target data packet, information for identifying the target data packet;
assigning, to a target burst, information for identifying the target burst;
enabling a first header of the target data packet to include at least one of the following: information for identifying the target data packet and information for identifying the target burst to which the target data packet belongs;
enabling a first header of the 1st data packet in the target burst to include a start indication of the target burst;
enabling a first header of the last data packet in the target burst to include an end indication of the target burst;
determining a first delay, where the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first sub-operation of the first operation includes at least one of the following:
enabling the first header of the target data packet to include at least one of the following: information for identifying the target data packet (such as a sequence number of the target data packet), information for identifying the target burst to which the target data packet belongs (such as a sequence number of the target burst), the first timestamp, and a first time;
determining a time corresponding to the first timestamp;
sending the first timestamp or the time corresponding to the first timestamp as the first time;
sending the target data packet to a first target end;
sending assistance information to the first target end, where the assistance information includes at least one of the following: the first information, third information, fifth information, and seventh information; and
receiving a first data packet after the target data packet is sent to the first target end, where a first header of the first data packet includes one of the following: information for identifying the target data packet, the first timestamp, the first time, and a second time.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs; and
the first source end is a data source end of the target data packet;
where
the first time is in a form of a time of sending the target data packet by the first communication device;
the second time is a time at which the target data packet arrives at the second communication device or the RAN network element; and
the third time is a time at which the target data packet arrives at a first communication device (such as an AS of the terminal).

According to a sixth aspect, an embodiment of this application provides a communication device, and the communication device is a second communication device, including:
an obtaining module, configured to obtain eighth information, where the eighth information includes at least one of the following: a first timestamp of a target data packet, a sampling frequency, information for identifying the target data packet, information for identifying a target burst to which the target data packet belongs, a second time of the target data packet, and a third time of the target data packet; and
a second execution module, configured to execute a second operation based on the eighth information.

The second operation includes at least one of the following:
determining a time corresponding to the first timestamp;
determining a first delay, where the first delay is one of the following: a required delay for a target data packet to pass between the first source end and a radio access network RAN network element, a time difference between a sampling time of the 1st byte of the target data packet and a time at which the target data packet arrives at a second communication device (such as a RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first timestamp is used to indicate one of the following: a packet sending time of the target data packet sent by the first source end and the sampling time of the 1st byte of the target data packet; and/or the first timestamp is a timestamp in a first header of the target data packet or a first timestamp in a form of a first time;
the first source end is a data source end of the target data packet;
the second time is a time at which the target data packet arrives at the second communication device or the RAN network element; and
the third time is one of the following: a time at which the target data packet arrives at the first communication device (for example, the AS or NAS of the terminal).

According to an eighth aspect, an embodiment of this application provides a communication device, and the communication device is a third communication device, including:
a third execution module, configured to perform a third operation, where
the performing a third operation includes at least one of the following:
performing a first sub-operation of the third operation, including at least one of the following: configuring a first monitoring configuration; configuring a second monitoring configuration; configuring first assistance information; configuring second assistance information; configuring a first requirement; sending at least one of the following to a third target end: the first monitoring configuration, the first requirement, and the first assistance information; and sending one of the following to a fourth target end: the second monitoring configuration and the second assistance information;
receiving at least one of first jitter information, third information, fifth information, and seventh information;
sending at least one of the first jitter information, the third information, the fifth information, and the seventh information;
determining the first jitter information based on the fifth information; and
determining at least one of the following based on the third information: a data packet transmission time interval, a data periodicity, a target burst to which the target data packet belongs, a boundary of the target burst, and a first feature;
where
the first monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
the second monitoring configuration is used for requesting to monitor a second delay, and the second delay is a delay (for example, a downlink delay) between an anchor user plane function (UPF) network element and a RAN network element; or, the second monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter; and
the first assistance information includes at least one of the following: a sampling frequency, a first feature, a data periodicity, a first time interval threshold, a second time interval threshold, and a third time interval threshold;
the second assistance information includes at least one of the following: a sampling frequency, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay;
the first requirement is used for requesting to send a first timestamp to a second communication device;
the first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs; and
the second time is a time at which the target data packet arrives at the second communication device or the RAN network element; and
the third time is a time at which the target data packet arrives at a first communication device;
where
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range;
where
the seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

According to a ninth aspect, an embodiment of this application provides a communication device, and the communication device is a fourth communication device, including:
a fourth execution module, configured to perform a fourth operation, where
the fourth operation includes at least one of the following:
performing a first sub-operation of the fourth operation;
sending at least one of the following to a fourth target end: a first monitoring requirement, a second requirement, and third assistance information;
receiving at least one of first jitter information, third information, fifth information, and seventh information;
determining the first jitter information based on the fifth information; and
determining at least one of the following based on the third information: a data packet transmission time interval, a data periodicity, a target burst to which the target data packet belongs, a boundary of the target burst, and a first feature.

The first sub-operation of the fourth operation includes at least one of the following:
configuring a first monitoring requirement, where the first monitoring requirement is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
configuring third assistance information, where the third assistance information includes at least one of the following: a sampling frequency, a first feature, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay; and
configuring a second requirement, where the second requirement is used for requesting to send a first timestamp to a second communication device.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element;
the third time is a time at which the target data packet arrives at a first communication device;
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst;
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

The seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

According to a tenth aspect, an embodiment of this application provides a communication device, and the communication device is a fifth communication device, including:
a fifth execution module, configured to perform a fifth operation, where
the fifth operation includes at least one of the following:
sending ninth information, where the ninth information includes at least one of the following:
a sampling frequency;
a first feature;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

According to an eleventh aspect, an embodiment of this application provides a communication device, including a processor, a memory, and a computer program stored on the memory and capable of running on the processor. When the computer program is executed by the processor, the steps of the information determining method according to the first aspect are implemented, or the steps of the information determining method according to the second aspect are implemented, or the steps of the information determining method according to the third aspect are implemented, or the steps of the information determining method according to the fourth aspect are implemented, or the steps of the information determining method according to the fifth aspect are implemented.

According to a twelfth aspect, an embodiment of this application provides a computer-readable storage medium. The computer-readable storage medium stores a computer program, and when the computer program is executed by a processor, the steps of the information determining method according to the first aspect are implemented, or the steps of the information determining method according to the second aspect are implemented, or the steps of the information determining method according to the third aspect are implemented, or the steps of the information determining method according to the fourth aspect are implemented, or the steps of the information determining method according to the fifth aspect are implemented.

### BRIEF DESCRIPTION OF DRAWINGS

FIG. 1 is a schematic architectural diagram of a wireless communication system according to an embodiment of this application;

FIGS. 2A to 2D are schematic diagrams of data packet transmission according to an embodiment of this application;

FIG. 3 is a flowchart of an information determining method according to an embodiment of this application;

FIG. 4 is a flowchart of another information determining method according to an embodiment of this application;

FIG. 5 is a flowchart of another information determining method according to an embodiment of this application;

FIG. 6 is a flowchart of another information determining method according to an embodiment of this application;

FIG. 7 is a flowchart of another information determining method according to an embodiment of this application;

FIG. 8 is a flowchart of another information determining method according to an embodiment of this application;

FIG. 9 is a flowchart of another information determining method according to an embodiment of this application;

FIG. 10 is a flowchart of another information determining method according to an embodiment of this application;

FIG. 11 is a structural diagram of a communication device according to this application;

FIG. 12 is a structural diagram of another communication device according to this application;

FIG. 13 is a structural diagram of another communication device according to this application;

FIG. 14 is a structural diagram of another communication device according to this application;

FIG. 15 is a structural diagram of another communication device according to this application;

FIG. 16 is a structural diagram of another communication device according to this application.

### DETAILED DESCRIPTION OF EMBODIMENTS

The following clearly and completely describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application without creative efforts shall fall within the protection scope of this application.

In the specification and claims of this application, the term “include” and any other variants thereof are intended to cover a non-exclusive inclusion. For example, a process, method, system, product, or device that includes a list of steps or units is not necessarily limited to those expressly listed steps or units, but may include other steps or units not expressly listed or inherent to such a process, method, product, or device. In addition, in the specification and claims, the use of “and/or” represents presence of at least one of the connected objects, for example, “A and/or B” indicates the following three cases: only A presents, only B presents, or both A and B present.

In the embodiments of this application, the word such as “an example” or “for example” is used to represent giving an example, an instance, or an illustration. Any embodiment or design solution described as “an example” or “for example” in the embodiments of this application shall not be interpreted to be more preferential or advantageous than other embodiments or design solutions. To be precise, the terms such as “an example” or “for example” are intended to present a related concept in a specific manner.

Technologies described in this specification are not limited to a 5th-generation mobile communication technology (5^{th} generation, 5G) system, a later evolved communications system, and an LTE/LTE-advanced (LTE-A) system, and may also be applied to various wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems.

The terms “system” and “network” are usually used interchangeably. A CDMA system can implement radio technologies such as CDMA2000, and universal terrestrial radio access (UTRA). The UTRA includes wideband CDMA (WCDMA) and other CDMA variants. The TDMA system can implement radio technologies such as the global system for mobile communications (GSM). An OFDMA system can implement a radio technology such as ultra mobile broadband (UMB), evolved UTRA (Evolution-UTRA, E-UTRA), IEEE 802.11 (wireless fidelity (Wi-Fi)), IEEE 802.16 (worldwide interoperability for microwave access (WiMAX)), IEEE 802.20, and fast low-latency access with seamless handoff-orthogonal frequency division multiplexing (Flash-OFDM). The UTRA and E-UTRA are parts of the universal mobile telecommunications system (UMTS). The LTE and more advanced LTE (such as LTE-A) are new UMTS releases that use the E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). Techniques described in this specification may be used in the aforementioned systems and radio technologies, and can also be used in other systems and radio technologies.

For better understanding the embodiments of this application, the following technical points are first described.

Transmission of some XR services is periodic, and data transmission is mainly performed at the beginning of a periodicity. For example, 10 ms is a periodicity, the first 3 ms is for data transmission, and the remaining 7 ms has no data transmission, so that a terminal may sleep in a “non-data transmission” interval, which makes the terminal energy-saving. However, delay overheads in the process of processing and sending data by a server to a RAN may be unstable, that is, there are jitters. If a jitter range can be provided to the RAN, it helps the RAN to determine an active time and sleep time of the terminal.

Causes of jitter generation mainly include the following two points:
(1) A package sending periodicity of the server may have a jitter change (for example, the periodicity fluctuates from 16.67 ms to 18 ms instead of one unique periodicity).
(2) There is a transmission delay difference for a data package between the server and the RAN. For example, if delay overheads of three data packets are 10 ms, 8 ms, and 9 ms respectively, the jitter range may be considered to be ±1 ms.

Generally, the jitter is mainly caused by (2).

The jitter range is provided to the RAN to determine a data transmission interval and/or a no data transmission interval. To support determining of the data transmission interval and/or the no data transmission interval, the following problems need to be resolved:

Problem 1: How to determine a starting base time of each burst?

Problem 2: How to determine the 1st data packet of each burst and an arrival time of the data packet?

Problem 3: How to obtain a first delay of a data packet (that is, a transmission delay of the data packet between the server and the RAN) in a burst (such as the 1st data packet in each burst).

Problem 4: The RAN does not support identification of other protocol headers except a GPRS tunneling protocol (GTP)-U header. At present, the timestamp is in a real-time transport protocol (RTP) header that cannot be identified by the RAN. How to make the RAN obtain timestamp information needs to be resolved.

Problem 5: For uplink data, a delay of data from the client to a modem of user equipment (UE) can be ignored. Therefore, a jitter caused by transmission can also be ignored. Similarly, an uplink data packet also has a timestamp. Based on timestamp, how to support the UE to report a processing delay difference needs to be solved.

Problem 6: The server does not use a same clock as the 5G System (5GS), which may affect determining of a no data transmission interval.

Problem 7: In one burst, there may also be an interval for packet sending by the server, and the packet sending interval may affect determining of a no data transmission interval.

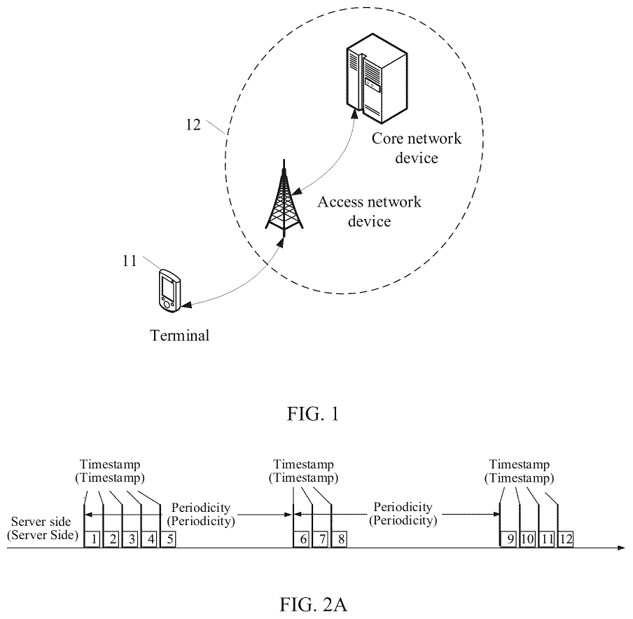

Referring to FIG. 1, FIG. 1 is a schematic architectural diagram of a wireless communication system provided in an embodiment of this application. The wireless communication system includes a terminal 11 and a network-side device 12. The terminal 11 can also be referred to as a terminal device or user equipment (UE). The terminal 11 may be a terminal-side device such as a mobile phone, a tablet computer (Tablet Personal Computer), a laptop computer or a notebook computer, a personal digital assistant (PDA), a palmtop computer, a netbook, an ultra-mobile personal computer (UMPC), a mobile Internet device (MID), a wearable device or vehicle user equipment (VUE), pedestrian user equipment (PUE). The wearable device includes: a smart watch, a wrist band, earphones, glasses, and the like. It should be noted that a specific type of the terminal 11 is not limited in the embodiments of this application. The network-side device 12 may include a base station, or a core network device. The base station may be referred to as a NodeB, an evolved NodeB, an access point, a base transceiver station (BTS), a radio base station, a radio transceiver, a basic service set (BSS), an extended service set (ESS), a Node B, an evolved Node B (eNB), a home NodeB, a home evolved NodeB, a wireless local area network (WLAN), a Wi-Fi node, a transmission and reception point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

Optionally, obtaining may be understood as acquiring from configuration, receiving, obtaining through receiving upon a request, obtaining through self-learning, obtaining through deduction based on non-received information, or obtaining through processing received information, which may be determined according to actual needs. This is not limited in some embodiments of this application. For example, when specific capability indication information transmitted by a device is not received, it can be deduced that the device does not support the capability.

Optionally, transmitting may include broadcasting, broadcasting through a system message, or returning a response after receiving the request.

In an optional embodiment of this application, the communication device may include at least one of the following: a communication network element and a terminal.

In an embodiment of this application, the communication network element may include at least one of the following: a core-network network element and a radio access network network element.

In the embodiments of this application, a core-network network element (CN network element) may include, but is not limited to, at least one of the following: a core-network device, a core-network node, a core-network function, a core-network network element, a mobility management entity (MME), an access mobility management function (AMF), a session management function (SMF), a user plane function (UPF), a serving gateway (serving GW, SGW), PDN gateway (PDN Gate Way, PDN), a policy control function (PCF), a policy and charging rules function (PCRF), general packet radio service (GPRS) serving support node (SGSN), a gateway GPRS support node (GGSN), and an application function.

In the embodiments of this application, a RAN network element may include, but is not limited to, at least one of the following: a radio access networks device, a radio access network node, a radio access network function, a radio access network unit, a 3GPP radio access network, a non-3GPP radio access network, a centralized unit (CU), a distributed unit (DU), a base station, an evolved NodeB (eNB), a 5G base station (gNB), a radio network controller (RNC), a base station (NodeB), a non-3GPP interworking function (N3IWF), an access controller (AC) node, an access-point (AP) device, a wireless local area network (WLAN) node, or a non-3GPP interworking function (N3IWF).

A base station may be a base transceiver station (BTS) in GSM or CDMA, or may be a NodeB in WCDMA, or may be an evolved NodeB (eNB or e-Node B) in LTE or a 5G NodeB (gNB), which is not limited in the embodiments of this application.

In an optional embodiment of this application, the UE may include one of the following: a terminal device, a terminal device and card, and a card.

In an optional embodiment of this application, the card may include one of the following: a subscriber identity module (Subscriber Identify Module, SIM) card, a universal subscriber identity module (Universal Subscriber Identity Module, USIM) card, and an electronic SIM (Embedded-SIM, eSIM) card.

In an optional embodiment of this application, the terminal may include a relay that supports a terminal function, and/or a terminal that supports a relay function. The terminal may also be referred to as a terminal device or user equipment (UE). The terminal may be a terminal-side device such as a mobile phone, a tablet computer (Tablet Personal Computer), a laptop computer, a personal digital assistant (PDA), a mobile Internet device (MID), a wearable device, or an in-vehicle device. It should be noted that a specific type of the terminal is not limited in this embodiments of this application.

In an optional embodiment of this application, a first time may also be referred to as a first local time.

In an optional embodiment of this application, a second time may also be referred to as a second local time.

In an optional embodiment of this application, a third time may also be referred to as a third local time.

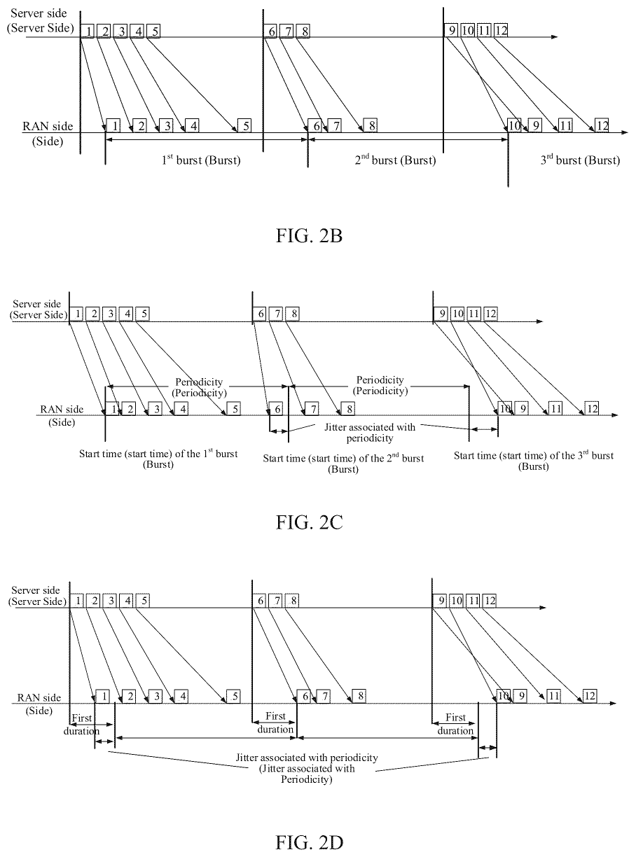

In an optional embodiment of this application, a jitter range and a first jitter range represent a same meaning and can be used interchangeably. The jitter range may also be referred to as a jitter interval. The first jitter information (including the first jitter range and/or the first jitter) may be jitter information associated with a data periodicity. The first jitter may be a jitter based on a predicted start time of a target burst (for example, a value of the first jitter in the downlink direction may be 1), that is, a time difference between a second time of a target data packet of the target burst first arriving at a second communication device and a start time of the target burst. As shown in FIG. 2B and FIG. 2C, for example, the value of the first jitter in the uplink direction may be 1, that is, a time difference between a third time of a target data packet of the target burst first arriving at a first communication device and a start time of the target burst.

In an optional embodiment of this application, the jitter and the first jitter represent a same meaning and can be used interchangeably.

In an optional embodiment of this application, the start time of the target burst is a predicted start time of the target burst.

In an optional embodiment of this application, the real start time of the target burst is one of the following: a third time of a target data packet of the target burst first arriving at the first communication device (such as the uplink direction), and a second time of the target data packet of the target burst first arriving at the second communication device (such as the downlink direction). The predicted start time of the target burst may be inferred based on a data periodicity. There is a difference between the real start time of the target burst and the predicted start time of the target burst, that is, a jitter.

In an optional embodiment of this application, the target data packet is a specific data packet. Concepts of the data and the data packet can be used interchangeably. Any one data packet of the target burst is also a target data packet.

In an optional embodiment of this application, a burst is a data burst, and one burst includes one or more data packets (or one or more data packet sets). There is a gap between bursts. The target burst can be a specific burst.

In an optional embodiment of this application, the 1st data packet of the target burst includes a first-arriving data packet of the target burst: a third time of a target data packet of the target burst first arriving at the first communication device (such as the uplink direction), and a second time of the target data packet of the target burst first arriving at the second communication device (such as the downlink direction).

In an implementation, the 1st data packet in the target burst includes one of the following: a data packet first sent in the target burst (such as a data packet first sent in the target burst from a first source end), a data packet first arriving in the target burst (such as a data packet first arriving at the RAN network element in the target burst), and a data packet first arriving at the terminal in the target burst (such as a data packet waiting to be sent).

In an implementation, the last data packet in the target burst includes one of the following: a data packet last sent in the target burst (such as a data packet last sent in the target burst from the first source end), a data packet last arrived in the target burst (such as a target data packet last arriving at the RAN network element in the target burst), and a data packet last arriving at the terminal in the target burst (such as a data packet waiting to be sent).

In an optional embodiment of this application, a tunnel may include at least one of the following: a protocol data unit (PDU) session, a quality of service (QoS) flow, an evolved packet system (EPS) bearer, a packet data protocol (PDP) context, a data radio bearer (DRB), a signaling radio bearer (SRB), and Internet protocol security (IPsec) association.

In an embodiment of this application, the NG interface is an interface between the RAN and the CN, which may also be referred to as an S1 interface or an N2 interface, and the naming is not limited.

In an embodiment of this application, the wireless communications network may be at least one of the following: a public network, a non-public network; or a first network may be a non-public network.

In an embodiment of this application, a non-public network is an abbreviation of non public network. The non-public network may be referred to as one of the following: a non-public communications network. The non-public network may include at least one of the following deployment manners: a physical non-public network, a virtual non-public network, and a non-public network implemented on a public network. In an implementation, the non-public network is a closed access group (CAG). A CAG may include a group of terminals.

In an embodiment of this application, the non-public network may include or be referred to as a private network. The private network may be referred to as one of the following: a private communication network, a private network, a local area network (LAN), a private virtual network (PVP), an isolated communication network, a dedicated communication network, or other names. It should be noted that a naming manner is not specifically limited in the embodiments of this application.

In an embodiment of this application, a public network is an abbreviation of public network. The public network may be referred to as one of the following: a public communications network or other names. It should be noted that a naming manner is not specifically limited in the embodiments of this application.

In an embodiment of this application, a data packet size may be referred to as a data packet length.

In an embodiment of this application, a data packet may be referred to as a data frame.

The following describes the information determining method in the embodiments of this application.

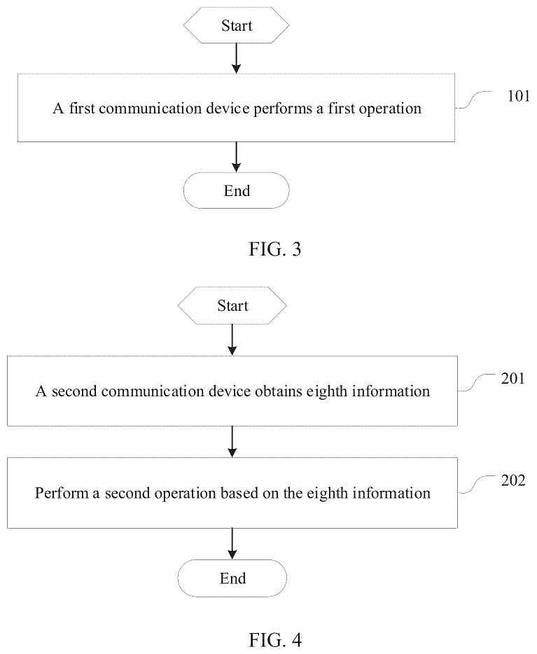

Refer to FIG. 3. An embodiment of this application provides an information determining method, which is applied to a first communication device. The first communication device includes but is not limited to a terminal or a CN network element (for example, but not limited to a UPF, a PCF, an SMF, and the like), and the method includes the following steps.

Step 101: The first communication device performs a first operation.

The performing a first operation includes at least one of the following:
obtaining first information, where the first information includes at least one of the following: a first timestamp of a target data packet, a sampling frequency, information for identifying the target data packet, and information for identifying a target burst to which the target data packet belongs;
performing a first sub-operation of the first operation based on the first information; and
performing a second sub-operation of the first operation;
where
the second sub-operation of the first operation includes at least one of the following:
determining a third time;
assigning, to a target data packet, information for identifying the target data packet;
assigning, to a target burst, information for identifying the target burst;
enabling a first header of the target data packet to include at least one of the following: information for identifying the target data packet and information for identifying the target burst to which the target data packet belongs;
enabling a first header of the 1st data packet in the target burst to include a start indication of the target burst;
enabling a first header of the last data packet in the target burst to include an end indication of the target burst;
determining a first delay, where the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first sub-operation of the first operation includes at least one of the following:
enabling the first header of the target data packet to include at least one of the following: information for identifying the target data packet (such as a sequence number of the target data packet), information for identifying the target burst to which the target data packet belongs (such as a sequence number of the target burst), the first timestamp, and a first time;
determining a time corresponding to the first timestamp;
sending the first timestamp or the time corresponding to the first timestamp as the first time;
sending the target data packet to a first target end;
sending assistance information to the first target end, where the assistance information includes at least one of the following: the first information, third information, fifth information, and seventh information; and
receiving a first data packet after the target data packet is sent to the first target end, where a first header of the first data packet includes one of the following: information for identifying the target data packet, the first timestamp, the first time, and a second time.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs; and
the first source end is a data source end of the target data packet;
where
the first time is in a form of a time of sending the target data packet by the first communication device;
the second time is a time at which the target data packet arrives at the second communication device or the RAN network element; and
the third time is a time at which the target data packet arrives at a first communication device (such as an AS of the terminal).

In an implementation, the first communication device may be any one of the following: a UPF, UE, a PCF, and an SMF.

In an implementation, the first target end may include at least one of the following: an N3 interface, an N9 interface, a Uu interface, a RAN network element, and a second communication device. For example, for a target data packet in an uplink direction, the first target end may include at least one of the following: a Uu interface, a RAN network element, and a second communication device. For example, for a target data packet in a downlink direction, the first target end may include at least one of the following: an N3 interface, an N9 interface, a RAN network element, and a second communication device;
where
the N3 interface is a user interface between the RAN and the CN, and the RAN network element or the second communication device can receive the target data packet sent by the UPF through the N3 interface.

The N9 interface is an interface between UPFs, and the UPF or the first communication device may receive a first data packet through the N9 interface.

The Uu interface is an interface between the RAN and the terminal, and the RAN may receive assistance information or the target data packet sent by the terminal through the Uu interface.

In an implementation, the first header includes one of the following: a GTP-U header, a service data adaption protocol (SDAP) header, a packet data convergence protocol (PDCP) header, a radio link control (RLC) header, and a media access control (MAC) header.

For the target data packet in the downlink direction, the first header includes a GTP-U header. The first header may be a header (such as a GTP-U header) added for the target data packet by the first communication device. The first header is used between GTP nodes (such as between N3 and/or N9 interfaces).

For the target data packet in the uplink direction, the first header includes one of the following: a SDAP header, a PDCP header, an RLC header, and a MAC header. The first header may be a header added by the first communication device for the target data packet (such as one of the following: a SDAP header, a PDCP header, an RLC header, and a MAC header), and the first header is used between Uu interfaces.

It should be noted that the first communication device and the first target end can perform communication through a protocol corresponding to the first header, and adding the first header to the target data packet facilitates communication with the first target end.

Information for identifying the target data packet is, for example, a data packet sequence number of the target data packet.

Information for identifying the target burst to which the target data packet belongs is, for example, a burst sequence number of the target burst.

In an implementation, the information for identifying the target data packet is received by the first communication device or assigned by the first communication device;

In an implementation, the information of the target burst is received by the first communication device or assigned by the first communication device.

In an implementation, information for identifying the target data packet may be included in the second header of the target data packet.

Alternatively, the data periodicity can represent one of the following: a data sending periodicity (a data sending interval has a periodic feature), or a data arrival periodicity (for example, a data arrival interval has a periodic feature, as shown in FIG. 2). In an implementation, the data periodicity is a periodicity of a burst. The data may include one or more target data packets. One burst can also contain one or more target data packets.

In an implementation, the 1st data packet in the target burst includes one of the following: a data packet first sent in the target burst (such as a data packet first sent in the target burst from a first source end), a data packet first arriving in the target burst (such as a data packet first arriving at the RAN network element in the target burst), and a data packet first arriving at the terminal in the target burst (such as a data packet waiting to be sent).

In an implementation, the last data packet in the target burst includes one of the following: a data packet last sent in the target burst (such as a data packet last sent in the target burst from the first source end), a data packet last arrived in the target burst (such as a data packet last arriving at the RAN network element in the target burst), and a data packet last arriving at the terminal in the target burst (such as a data packet waiting to be sent).

In an implementation, a first header of the first data packet includes one of the following: information for identifying the target data packet, the first timestamp, the first time, and a second time. It is not difficult to understand that the target data packet can be associated based on the information used for identifying the target data packet in the first data packet.

It is not difficult to understand that in the downlink direction, in a case that there are multiple target data packets, only one target data packet is the data packet that first arrives at the RAN network element in the target burst. The data packet first arriving at the target RAN network element needs to be determined jointly based on the second time and the first timestamp. If the first communication device has not sent the first timestamp to the first target end before, the first timestamp is not returned in the first data packet, and in this case, the target data packet and the first timestamp of the target data packet can be associated based on the information used for identifying the target data packet.

It is not difficult to understand that in the uplink direction, in a case that there are multiple target data packets, only one target data packet is the data packet that first arrives at the terminal (such as the AS of the terminal) in the target burst. The data packet first arriving at the target terminal can be determined based on the first timestamp or the third time.

The information for identifying the target data packet includes: a sequence number of the target data packet.

The information used for identifying the target burst to which the target data packet belongs includes a sequence number of the target burst.

In an implementation, after using the time corresponding to the first timestamp (such as a timestamp in an RTP/secure real-time transport protocol (SRTP)) header as the first time for sending the target data packet by the first communication device, the first communication device sends the target data packet to the first target end.

In an implementation, for downlink, the first delay is a data transmission delay between the server sending the target data packet and the RAN network element. For uplink, the first delay is a delay from the time that the target data packet is sent by the client to the time that the target data packet arrives at the UE and starts waiting to be scheduled.

In an implementation, the data packet transmission time interval includes one of the following: a packet sending time interval of the first source end and a transmission time interval between two consecutive data packets.

In an implementation, the terminal sends assistance information to the first target end. The assistance information is energy-saving related assistance information.

In an implementation, enabling (enable) the first header of the target data packet to include at least one of the following may mean setting the first header of the target data packet to make the first header include at least one of the following.

In an implementation, the data packet transmission time interval may be a transmission time interval between two data packets.

Optionally, the first timestamp is included in the second header of the target data packet;
or
the first timestamp is a timestamp converted from a second timestamp based on a first clock, and the second timestamp is a timestamp in the second header of the target data packet.

The first clock is a clock used by the first communication device or a clock used by the second communication device.

In an implementation, the second header is one of the following: when the first communication device (such as one of the following: the AS of the terminal, the NAS of the terminal, or the UPF) receives the target data packet, a header (such as an RTP header, an SRTP header, a real-time control protocol (RTCP) header) that the target data packet already has.

In an implementation, when the first source end is synchronized with the first clock, the first timestamp is directly a timestamp in the second header of the target data packet.

In an implementation, when the first source end (using a second clock) is not synchronized with the first clock, it is not difficult to understand that the timestamp in the second header of the target data packet is a packet sending timestamp of the target data packet sent by the first source end based on the second clock. In this case, the timestamp in the second header of the target data packet needs to be converted into a timestamp based on the first clock.

Optionally, the first information further includes:
a first time difference, where the first time difference is a time difference between a clock used by the first source end and a clock used by the first communication device or the second communication device;
a data periodicity;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

In an implementation, the arrival time is one of the following: a time of arriving at the first communication device (such as the AS of the terminal) or a time of arriving at the second communication device (such as the RAN network element).

In an implementation, when the first source end (using the second clock) is not synchronized with the first clock, the second clock and the first clock can be compared to obtain a first time difference, and the first clock is a clock used by the first communication device or a clock used by the second communication device.

In an implementation, the first communication device can obtain at least one of the following from the third communication device (such as an SMF), the fourth communication device (such as a PCF), or the fifth communication device (such as Application Function (AF)): a first time difference, a first time interval threshold, a second time interval threshold, and a third time interval threshold.

Optionally, the determining a first delay includes: determining the first delay based on second information.

The second information includes at least one of the following:
a first timestamp, a first time, a second time, and/or a third time of one or more target data packets.

Optionally, the determining the first delay based on second information includes one of the following:
determining the first delay based on a difference between a second time of the target data packet and a first time of the target data packet;
determining the first delay based on a difference between the second time of the target data packet and a first timestamp or a time corresponding to the first timestamp of the target data packet; and
determining the first delay based on a difference between a third time of the target data packet and the first timestamp or the time corresponding to the first timestamp of the target data packet.

In an implementation, the first delay may be a difference between the second time and the first time.

In an implementation, the first delay may be a difference between the second time and the time corresponding to the first timestamp.

In an implementation, the first delay may be a difference between the third time and the time corresponding to the first timestamp. For the downlink, in a case that a delay between the RAN and the anchor gateway changes slightly or is approximately the same, the delay between the anchor gateway and the server can be used to collect statistics about a first delay and calculate a jitter range. For the uplink, the first delay is a delay between the client and the NAS or AS of the terminal.

Optionally, the determining at least one of the following: a data packet transmission time interval, a data periodicity, a target burst to which the target data packet belongs, a boundary of the target burst, and a first feature includes:
determining at least one of the following based on the third information: a data packet transmission time interval, a data periodicity, a target burst to which the target data packet belongs, a boundary of the target burst, and a first feature.

The third information includes:
a first timestamp, a first time, a second time, and/or a third time of one or more target data packets.

The plurality is greater than or equal to two.

Optionally, the one or more target data packets are the 1st data packets of one or more target bursts.

Optionally, the first feature is used to indicate one of the following: a data flow transmission has a periodic feature, and a data flow transmission has no periodic feature;

In an implementation, data flow transmission includes one of the following: data flow sending and data flow arrival.

In an implementation, the data packet transmission time interval includes one of the following: a transmission time interval between two consecutive data packets (such as a packet sending time interval of the first source end) and an arrival time interval of two consecutive data packets (such as a time interval of arriving at the RAN).

In an implementation, a transmission periodicity for the transmission time interval data between two consecutive data packets includes one of the following: a data sending periodicity and a data arrival periodicity.

As shown in FIG. 2A, it is not difficult to understand that the boundary of the target burst can be determined based on the first timestamp, for example, data packets with a long interval are not in one target burst, and data packets with a short interval are in one target burst.

As shown in FIG. 2A, it is not difficult to understand that whether the data flow has a periodic feature can be determined based on the first timestamp. For example, a uniform interval of consecutive target bursts means that the data flow transmission has a periodic feature, and an uneven interval means not having a periodic feature.

For a data flow with a periodic feature, a length of the data periodicity can be determined based on the first timestamp or the second time of the 1st data packet of each target burst. For example, as shown in FIG. 2A, a length of the data sending periodicity can be determined based on first timestamps of the 1st data packets of every two target bursts. For example, as shown in FIG. 2B, a length of the data arrival periodicity can be determined based on second times of the 1st data packets of every two target bursts.

In an implementation, based on first timestamps of the plurality of target data packets, at least one of the following can be determined: a transmission time interval between two consecutive data packets, a data periodicity (such as a data sending periodicity), and a first feature (such as data flow sending having a periodic feature or data flow sending not having a periodic feature).

In an implementation, based on first timestamps and/or second times of the plurality of target data packets, at least one of the following can be determined: an arrival time interval between two consecutive data packets, a data periodicity (such as a data arrival periodicity), and a first feature (such as data flow arrival having a periodic feature or data flow arrival not having a periodic feature). Secondly, based on the second time, an arrival time interval of data packets, an arrival periodicity of data, and a first jitter can be determined.

Optionally, the determining related information of the target burst includes:
determining the related information of the target burst based on fourth information.

The fourth information includes at least one of the following:
a first timestamp, a first time, a second time, and a third time of one or more target data packets, and/or information for identifying the target data packet;
a transmission time interval between two consecutive data packets;
a data periodicity;
a first duration; and
a time corresponding to the 1st data packet of the 1st burst;
where
the first duration is used for adjusting a predicted start time of the target burst; and an adjusted start time of the target burst is a start time of the target burst before adjustment plus the first duration; and
the time corresponding to the 1st data packet of the 1st burst is one of the following: a second time of the 1st data packet of the 1st burst, a third time of the 1st data packet of the 1st burst, and a time corresponding to a first timestamp of the 1st data packet of the 1st burst.

In an implementation, the first duration may be a statistical result obtained by averaging a plurality of first delays.

As shown in FIG. 2B or FIG. 2C, from the receive end, it is difficult to determine which packet is in the target burst.

However, based on the first timestamp of the target data packet, target data packets included in the target burst can be determined, for example, data packets included in the 1st burst is 1, 2, 3, 4, and 5; data packets in the 2nd burst are 6, 7, and 8, and data packets in the 3rd burst are 9, 10, 11, and 12. In this case, if each data packet carries an identifier (such as a burst sequence number) of a burst to which the data packet belongs, at the receive end, the related information of the target burst can be determined at the receive end, for example, the 1st data packet and the last data packet of the burst can be determined. For example, based on sequence numbers of the 1st data packet and the last data packet in the target burst, all data packets in the burst, including the 1st data packet and the last data packet in the burst, can be then determined.

Optionally, the determining the related information of the target burst based on fourth information includes at least one of the following:
determining all data packets in the target burst based on a sequence number of the 1st data packet in the target burst and a sequence number of the last data packet in the target burst;
determining a start time of the N-th target burst based on a time and a data periodicity corresponding to the 1st data packet of the M-th burst;
determining a data periodicity based on to first timestamps of the 1st data packets of a plurality of target bursts;
determining a data periodicity based on second times of the 1st data packets of the plurality of target burst;
determining a data periodicity based on third times of the 1st data packets of the plurality of target burst;
performing a first determining operation in a case that a first condition is met; and
performing a second determining operation in a case that a second condition is met.

The first determining operation includes at least one of the following:
determining that a second data packet is the last data packet in the N-th target burst;
determining that a third data packet is the 1st data packet in the (N+1)-th target burst;
determining that a data transmission end time of the N-th target burst is one of the following: a time corresponding to a first timestamp of the second data packet, a third time of the second data packet, a time corresponding to the first timestamp of the second data packet plus the first duration, and a second time of the second data packet; and
determining that a start time of the (N+1)-th target burst is one of the following: a time corresponding to a first timestamp of the third data packet, a third time of the third data packet, a time corresponding to the first timestamp of the third data packet plus the first duration, and a second time of the third data packet.

The second determining operation includes at least one of the following:
determining that the second data packet and the third data packet are data packets in one target burst; and
determining that a fourth data packet is a data packet in the target burst.

The first condition includes at least one of the following:
a time interval between the first timestamp of the second data packet and the first timestamp of the third data packet is greater than or equal to a first time interval threshold; and
a sending time interval between the second data packet and the third data packet is greater than or equal to the first time interval threshold.

The second condition includes at least one of the following:
a time interval between a first timestamp of the fourth data packet and a first timestamp of the 1st data packet in the target burst is less than or equal to a second time interval threshold; and
a sending time interval between the second data packet and the third data packet is less than or equal to a third time interval threshold; where
N is an integer greater than or equal to 1; and
the second data packet and the third data packet are any two consecutive target data packets, and the fourth data packet is one target data packet in one or more target data packets.

It is not difficult to understand that based on the sequence number of the 1st data packet and the sequence number of the last data packet in the target burst, the 1st data packet and the last data packet in the target burst can be determined, and based on continuity of received data packets, a data packet next to the 1st data packet can be determined as the 2nd data packet, and in this way, all data packets in the target burst can be determined.

It is not difficult to understand that based on the first timestamp of the target data packet, the transmission time interval between two consecutive data packets can be determined, and in a case that a sending time interval between a second data packet and a third data packet is long enough (for example, being greater than the first time interval threshold), the third data packet can be determined as a start data packet of the next burst.

In an implementation, the second data packet and the third data packet are any two consecutive data packets in a plurality of target data packets.

In an implementation, the first time interval threshold, the second time interval threshold, and the third time interval threshold are thresholds received by the first communication device, or thresholds configured in the first communication device.

The first duration is shown in FIG. 2D.

Optionally, the determining a start time of the N-th target burst based on a time and a data periodicity corresponding to the 1st data packet of the M-th burst includes:
determining that the start time of the N-th target burst is one of the following:
a time corresponding to the 1st data packet of the M-th burst+(N−M)*a data periodicity; and
a value of M is any positive integer greater than or equal to 1.

For example, as shown in FIG. 2C, M=1, the start time of the N-th target burst=a time corresponding to the 1st data packet of the 1st burst+(N−1)*a data periodicity.

For example, as shown in FIG. 2D, M=2, the start time of the N-th target burst=a time corresponding to the 1st data packet of the 2nd burst+(N−1)*a data periodicity.

Optionally, the determining the first jitter information includes:
determining the first jitter information based on the fifth information; and
the fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

The first jitter information may be jitter information associated with the data periodicity. The first jitter may be a jitter based on a predicted start time of a target burst (for example, a value of the first jitter in the downlink direction may be 1), that is, a time difference between a second time of a target data packet of the target burst first arriving at a second communication device and a start time of the target burst. As shown in FIG. 2B and FIG. 2C, for example, the value of the first jitter in the uplink direction may be 1, that is, a time difference between a third time of a target data packet of the target burst first arriving at a first communication device and a start time of the target burst.

The start time of the target burst is a predicted start time of the target burst.

The real start time of the target burst is one of the following: a third time of a target data packet of the target burst first arriving at the first communication device (such as the uplink direction), and a second time of the target data packet of the target burst first arriving at the second communication device (such as the downlink direction). The predicted start time of the target burst may be inferred based on a data periodicity. There is a difference between the real start time of the target burst and the predicted start time of the target burst, that is, a jitter.

In another implementation, statistics about the plurality of first delays can be collected, and the first jitter range can be determined based on a statistical result.

As shown in FIG. 2C, the first jitter may be a time interval between the arrival time of the first-arriving data packet of the burst and the start time of the burst. For example, in the 2nd burst, the arrival time of the 1st data packet of the burst is earlier than the start time of the burst, for example, in the 3rd burst, the arrival time of the 1st data packet of the burst is later than the start time of the burst. A jitter range of [−X,+Y] can be obtained through statistics collection, that is a range of jitter, and the first jitter information may include the jitter range.

It should be noted that the bursts are spaced based on a periodicity, and there are two understandings on the start time of the burst.

Understanding 1: If the 1st data packet of the 1st burst is used as the start time (T21) of the 1st burst, the start time of the N-th burst is T21+(N−1)*a periodicity.

In this case, the first delay=the arrival time of the data packet−the start time of the target burst (T21+(n−1)*a periodicity).

Understanding 2: The timestamp of the data packet (such as T11/T12/T13/T14/T15) is used as a benchmark. For example, the 1st data packet is the 1st data packet of the 1st burst. A time interval between a timestamp of the 6th data packet and a timestamp of the 5th data packet is relatively long, and the 6th data packet can be understood as the 1st data packet of the 2nd burst. Similarly, a time interval between a timestamp of the 7th data packet and the 6th data packet is relatively long, and the 7th data packet can be understood as the 1st data packet of the 3rd burst.

In this case, the first delay=the arrival time of the data packet−the start time of the target burst (such as the time corresponding to the first timestamp of the 1st data packet in the target burst).

Optionally, the determining the first jitter information based on the fifth information includes one of the following:
determining the first jitter based on one of the following: a second time of the 1st data packet in the target burst and a start time of the target burst; and a third time of the 1st data packet in the target burst and a start time of the target burst;
collecting statistics about one or more first jitters, and determining at least one of the following based on a statistical result of the first jitter: a first jitter range, a first duration, and an adjusted start time of the target burst;
collecting statistics about one or more first delays, and determining at least one of the following based on a statistical result of the first delay: a first jitter range, and a start time of the target burst; and
collecting statistics about one or more first intervals, and determining at least one of the following based on a statistical result of the first interval: a first jitter range, a first duration, and an adjusted start time of the target burst.

The first interval is one of the following: a time difference between the second time of the 1st data packet in the target burst and the start time of the target burst, and a time difference between the second time of the 1st data packet in the target burst and the start time of the target burst;
the first duration is used for adjusting a predicted start time of the target burst; and
the adjusted start time of the target burst is a start time of the target burst before adjustment plus the first duration.

In an implementation, the first duration is a positive value or a negative value.

The determining the first jitter based on the second time of the target data packet in the target burst (for example, the target data packet first arriving at the second communication device in the target burst) and the start time of the target burst includes that the first jitter is a difference between the second time of the target data packet in the target burst and the start time of the target burst.

The first duration is shown in FIG. 2D.

In an implementation, the first duration may be a statistical result obtained by performing statistics collection processing on a plurality of first delays. For example, as shown in FIG. 2D, the plurality of first delays may include 8 ms, 9 ms, and 10 ms, and then the first duration may be: (8+9+10)/3=9 ms or 8 ms. It means that an adjusted start time of the target burst is uniformly delayed by a first duration. When the first duration is 9 ms, a jitter value of the first delay being 8 ms is −1 ms, a jitter value of the first delay being 9 ms is 0 ms, a jitter value of the first delay being 10 ms is 1 ms, and the jitter range is [−1,1]. When the first duration is 8 ms, a jitter value of the first delay being 8 ms is 0 ms, a jitter value of the first delay being 9 ms is 1 ms, a jitter value of the first delay being 10 ms is 1 ms, and the first jitter range is [0,2].

Optionally, the determining a time corresponding to a first timestamp includes: determining the time corresponding to the first timestamp based on sixth information.

The sixth information includes at least one of the following: a first timestamp, a sampling frequency, and a time of the 1st data packet of the 1st burst.

For example, for a signal sampled at 8 kHz in a sampling frequency domain, if one data block is formed every 20 ms, one data block includes 160 samples (0.02×8000=160). Therefore, every time one RTP packet is sent, a value of its timestamp increases by 160.

It is not difficult to understand that the time interval can be calculated based on a difference between the sampling frequency and the first timestamp (the first timestamp of the target data packet and the first timestamp of the 1st data packet of the 1st burst); and the time corresponding to the first timestamp can be inferred based on both the time (such as an arrival time) of the 1st data packet of the 1st burst (a data packet first sent or a data packet first arriving at the first communication device or the second communication device).

Optionally, the first source end includes at least one of the following: a server, a terminal, and a client.

In an implementation, the client is located at an application layer of the terminal. The first communication device may be the AS or the NAS of the terminal. The AS or NAS of the terminal obtains the first information from an application client of the terminal.

Optionally, the first header includes one of the following: a GTP-U header, a SDAP header, a PDCP header, an RLC header, and a MAC header; and/or
the second header includes one of the following: a protocol header added by the first communication device for the target data packet, an RTP header, and an SRTP header.

Optionally, before the performing, by a first communication device, a first operation, the method further includes at least one of the following:
receiving a first monitoring configuration, where the first monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
receiving a first requirement, where the first requirement is used for requesting to send the first timestamp to the second communication device; and
receiving first assistance information, where the first assistance information includes at least one of the following: a sampling frequency, a first feature, a data periodicity, a first time interval threshold, a second time interval threshold, and a third time interval threshold.

In an implementation, the first communication device includes a UPF, and the first communication device receives a first monitoring configuration sent by a third communication device (such as an SMF), a first requirement, and/or first assistance information.

In an implementation, the first communication device includes a terminal, and the first communication device receives a first monitoring configuration sent by the third communication device (such as an SMF, an AMF, or a RAN) and/or a first requirement.

Optionally, after the performing, by a first communication device, a first operation, the method further includes:
sending the first jitter information, the third information, the fifth information, and/or the seventh information, where the seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

The sending the first jitter information, the fifth information, and/or the seventh information includes: sending the first jitter information, the fifth information and/or the seventh information to the second target end.

In an implementation, the second target end includes one of the following: a third communication device (such as an SMF), a fourth communication device (such as a PCF), or a second communication device (such as a RAN).

Optionally, the target data packet is a downlink data packet;
and/or
the data packet transmission time interval is a data packet transmission time interval in a downlink direction.
and/or
the data periodicity is a data periodicity in the downlink direction.
and/or
the related information of the target burst is related information of the target burst in the downlink direction;
and/or
the first jitter information is first jitter information in the downlink direction;
and/or
the first delay is a first delay in the downlink direction.

Optionally, the target data packet is an uplink data packet;
and/or
the data packet transmission time interval is a data packet transmission time interval in an uplink direction;
and/or
the data periodicity is a data periodicity in the uplink direction;
and/or
the related information of the target burst is related information of the target burst in the uplink direction.

Optionally, the performing a second sub-operation of the first operation includes: performing the second sub-operation of the first operation based on a first timestamp, a first time, a second time, and/or a third time of one or more target data packets.

Optionally, the target data packet is one of the following: the 1st data packet in the target burst.

In an implementation, the 1st data packet of the target burst includes a data packet that first arrives in the target burst.

For downlink, a data packet first arriving in the target burst represents a data packet first arriving at the second communication device (such as the RAN network element) in the target burst.

For uplink, a data packet first arriving in the target burst represents a data packet that first arrives at the first communication device (such as the terminal (such as the AS or NAS of the terminal)) in the target burst, such as a data packet arriving at the AS of the terminal and waiting to be sent.

In the embodiments of this application, the first operation is performed so as to support determining a data transmission interval and/or a no data transmission interval, so that the terminal can sleep in the no data transmission interval, implementing energy-saving for the terminal.

Refer to FIG. 4. An embodiment of this application provides an information determining method, which is applied to a second communication device. The second communication device includes but is not limited to a RAN network element, and the method includes the following steps.

Step 201: The second communication device obtains eighth information, where the eighth information includes at least one of the following: a first timestamp of a target data packet, a sampling frequency, information for identifying the target data packet, information for identifying a target burst to which the target data packet belongs, a second time of the target data packet, and a third time of the target data packet.

Step 202: Perform a second operation based on the eighth information.

The second operation includes at least one of the following:
determining a time corresponding to the first timestamp;
determining a first delay, where the first delay is one of the following: a required delay for a target data packet to pass between the first source end and a radio access network RAN network element, a time difference between a sampling time of the 1st byte of the target data packet and a time at which the target data packet arrives at a second communication device (such as a RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first timestamp is used to indicate one of the following: a packet sending time of the target data packet sent by the first source end and the sampling time of the 1st byte of the target data packet; and/or the first timestamp is a timestamp in a first header of the target data packet or a first timestamp in a form of a first time;
the first source end is a data source end of the target data packet;
the second time is a time at which the target data packet arrives at the second communication device or the RAN network element; and
the third time is one of the following: a time at which the target data packet arrives at the first communication device (for example, the AS or NAS of the terminal).

In an implementation, the second communication device includes a RAN.

Details of the information in the second operation are as described in the first communication device in the embodiment of FIG. 3, and are not repeated here.

In an implementation, in a case that the first timestamp of the target data packet is received in a form of the first time of the target data packet, the first timestamp may also be referred to as the first time in the second communication device.

Optionally, the obtaining eighth information includes at least one of the following:
receiving, by the second communication device, a target data packet from a second source end, where the first header of the target data packet includes at least one of the following: the eighth information, the first timestamp of the target data packet, the information for identifying the target data packet, the information for identifying the target burst to which the target data packet belongs, and the third time of the target data packet;
recording, by the second communication device, a time at which the target data packet arrives at the second communication device, so as to obtain the second time of the target data packet;
receiving, by the second communication device, assistance information from a third source end, where the assistance information includes at least one of the following: the eighth information; and
receiving, by the second communication device, a signaling message from a fourth source end, where the signaling message includes at least one of the following: the eighth information, and a sampling frequency.

In an implementation, the first source end includes at least one of the following: a server, a terminal, and a client.

In an implementation, the second source end includes at least one of the following: an N3 interface, a user plane function UPF, a Uu interface, a terminal, and a first communication device. For the target data packet in a downlink direction, the second source end includes at least one of the following: an N3 interface, a user plane function UPF, and a first communication device (such as a UPF and a PSA). For the target data packet in an uplink direction, the second source end includes at least one of the following: a Uu interface, a terminal, and a first communication device (such as the terminal).

In an implementation, the third source end includes at least one of the following: a Uu interface and a terminal.

In an implementation, the fourth source end includes at least one of the following: an NG interface, an AMF, a third communication device (such as an SMF), and a fourth communication device (such as a PCF).

Optionally, the first timestamp is a timestamp converted from a second timestamp based on a first clock, and the second timestamp is a timestamp in the first header of the target data packet.

The first clock is a clock used by the first communication device or a clock used by the second communication device.

Optionally, the eighth information further includes:
a first time difference, where the first time difference is a time difference between a clock used by the first source end and a clock used by the first communication device or the second communication device;
a data periodicity;
a first time of the target data packet;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

In an implementation, the first time is in a form of a time of sending the target data packet by the first communication device, which may be a first timestamp or a time corresponding to the first timestamp.

In an implementation, when the first source end (using the second clock) is not synchronized with the first clock, the second clock and the first clock can be compared to obtain a first time difference, and the first clock is a clock used by the first communication device or a clock used by the second communication device.

In an implementation, the first communication device can obtain at least one of the following from the third communication device (such as an SMF), the fourth communication device (such as a PCF), or the fifth communication device (such as an AF): a first time difference, a first time interval threshold, a second time interval threshold, and a third time interval threshold.

Optionally, the determining a first delay includes: determining the first delay based on second information.

The second information includes at least one of the following:
a first timestamp, a first time, a second time, and/or a third time of one or more target data packets.

Optionally, the determining the first delay based on second information includes one of the following:
determining the first delay based on a difference between the second time of the target data packet and a first time of the target data packet;
determining the first delay based on a difference between the second time of the target data packet and a first timestamp or a time corresponding to the first timestamp of the target data packet; and
determining the first delay based on a difference between a third time of the target data packet and the first timestamp or the time corresponding to the first timestamp of the target data packet.

Optionally, the determining at least one of the following: a data packet transmission time interval, a data periodicity, a target burst to which the target data packet belongs, a boundary of the target burst, and a first feature includes:
determining at least one of the following based on the third information: a data packet transmission time interval, a data periodicity, a target burst to which the target data packet belongs, a boundary of the target burst, and a first feature.

The third information includes:
a first timestamp, a first time, a second time, and/or a third time of one or more target data packets.

The plurality is greater than or equal to two.

Optionally, the one or more target data packets are the 1st data packets of one or more target bursts.

Optionally, the determining related information of the target burst includes:
determining the related information of the target burst based on fourth information.

The fourth information includes at least one of the following:
a first timestamp, a first time, a second time, and a third time of one or more target data packets, and/or information for identifying the target data packet;
a transmission time interval between two consecutive data packets;
a data periodicity;
a first duration; and
a time corresponding to the 1st data packet of the 1st burst;
where
the first duration is used for adjusting a predicted start time of the target burst; and an adjusted start time of the target burst is a start time of the target burst before adjustment plus the first duration; and
the time corresponding to the 1st data packet of the 1st burst is one of the following: a second time of the 1st data packet of the 1st burst, a third time of the 1st data packet of the 1st burst, and a time corresponding to a first timestamp of the 1st data packet of the 1st burst.

Optionally, the determining the related information of the target burst based on fourth information includes at least one of the following:
determining all data packets in the target burst based on a sequence number of the 1st data packet in the target burst and a sequence number of the last data packet in the target burst;
determining a start time of the N-th target burst based on a time and a data periodicity corresponding to the 1st data packet of the M-th burst;
determining a data periodicity based on to first timestamps of the 1st data packets of a plurality of target bursts;
determining a data periodicity based on second times of the 1st data packets of the plurality of target burst;
determining a data periodicity based on third times of the 1st data packets of the plurality of target burst;
performing a first determining operation in a case that a first condition is met; and
performing a second determining operation in a case that a second condition is met.

The first determining operation includes at least one of the following:
determining that a second data packet is the last data packet in the N-th target burst;
determining that a third data packet is the 1st data packet in the (N+1)-th target burst;
determining that a data transmission end time of the N-th target burst is one of the following: a time corresponding to a first timestamp of the second data packet, a third time of the second data packet, a time corresponding to the first timestamp of the second data packet plus the first duration, and a second time of the second data packet; and
determining that a start time of the (N+1)-th target burst is one of the following: a time corresponding to a first timestamp of the third data packet, a third time of the third data packet, a time corresponding to the first timestamp of the third data packet plus the first duration, and a second time of the third data packet.

The second determining operation includes at least one of the following:
determining that the second data packet and the third data packet are data packets in one target burst; and
determining that a fourth data packet is a data packet in the target burst.

The first condition includes at least one of the following:
a time interval between the first timestamp of the second data packet and the first timestamp of the third data packet is greater than or equal to a first time interval threshold; and
a sending time interval between the second data packet and the third data packet is greater than or equal to the first time interval threshold.

The second condition includes at least one of the following:
a time interval between a first timestamp of the fourth data packet and a first timestamp of the 1st data packet in the target burst is less than or equal to a second time interval threshold; and
a sending time interval between the second data packet and the third data packet is less than or equal to a third time interval threshold; where
N is an integer greater than or equal to 1; and
the second data packet and the third data packet are any two consecutive target data packets, and the fourth data packet is one target data packet in one or more target data packets.

Optionally, the determining a start time of the N-th target burst based on a time and a data periodicity corresponding to the 1st data packet of the M-th burst includes:
determining that the start time of the N-th target burst is one of the following:
a time corresponding to the 1st data packet of the M-th burst+(N−M)*a data periodicity.

A value of M is any positive integer greater than or equal to 1.

Optionally, the determining the first jitter information includes:
determining the first jitter information based on the fifth information; and
the fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

Optionally, the determining the first jitter information based on the fifth information includes one of the following:
determining the first jitter based on one of the following: a second time of the 1st data packet in the target burst and a start time of the target burst; and a third time of the 1st data packet in the target burst and a start time of the target burst;
collecting statistics about one or more first jitters, and determining at least one of the following based on a statistical result of the first jitter: a first jitter range, a first duration, and an adjusted start time of the target burst;
collecting statistics about one or more first delays, and determining at least one of the following based on a statistical result of the first delay: a first jitter range, and a start time of the target burst; and
collecting statistics about one or more first intervals, and determining at least one of the following based on a statistical result of the first interval: a first jitter range, a first duration, and an adjusted start time of the target burst.

The first interval is one of the following: a time difference between the second time of the 1st data packet in the target burst and the start time of the target burst, and a time difference between the second time of the 1st data packet in the target burst and the start time of the target burst;
the first duration is used for adjusting a predicted start time of the target burst;
the adjusted start time of the target burst is a start time of the target burst before adjustment plus the first duration; and
the first duration is a positive value or a negative value.

Optionally, the determining a time corresponding to a first timestamp includes: determining the time corresponding to the first timestamp based on sixth information.

The sixth information includes at least one of the following: a first timestamp, a sampling frequency, and a time of the 1st data packet of the 1st burst.

Optionally, the first source end includes at least one of the following: a server, a terminal, and a client.

Optionally, the first header includes one of the following: a GTP-U header, a SDAP header, a PDCP header, an RLC header, and a MAC header.

Optionally, the target data packet is a downlink data packet;
and/or
the data packet transmission time interval is a data packet transmission time interval in a downlink direction.
and/or
the data periodicity is a data periodicity in the downlink direction.
and/or
the related information of the target burst is related information of the target burst in the downlink direction;
and/or
the first jitter information is first jitter information in the downlink direction;
and/or
the first delay is a first delay in the downlink direction.

Optionally, the target data packet is an uplink data packet;
and/or
the data packet transmission time interval is a data packet transmission time interval in an uplink direction;
and/or
the data periodicity is a data periodicity in the uplink direction;
and/or
the related information of the target burst is related information of the target burst in the uplink direction.

Optionally, before the performing, by a second communication device, a second operation, the method further includes at least one of the following:
receiving a second monitoring configuration, where the second monitoring configuration is used for requesting to monitor a second delay, and the second delay is a delay between an anchor user plane function UPF network element and a RAN network element; or, the second monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter; and
receiving second assistance information, where the second assistance information includes at least one of the following: a sampling frequency, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay.

In an implementation, the second communication device includes a RAN, and the first communication device receives a second monitoring configuration sent by the third communication device (such as an SMF) and/or second assistance information.

In the embodiments of this application, the first operation is performed so as to support determining a data transmission interval and/or a no data transmission interval, so that the terminal can sleep in the no data transmission interval, implementing energy-saving for the terminal.

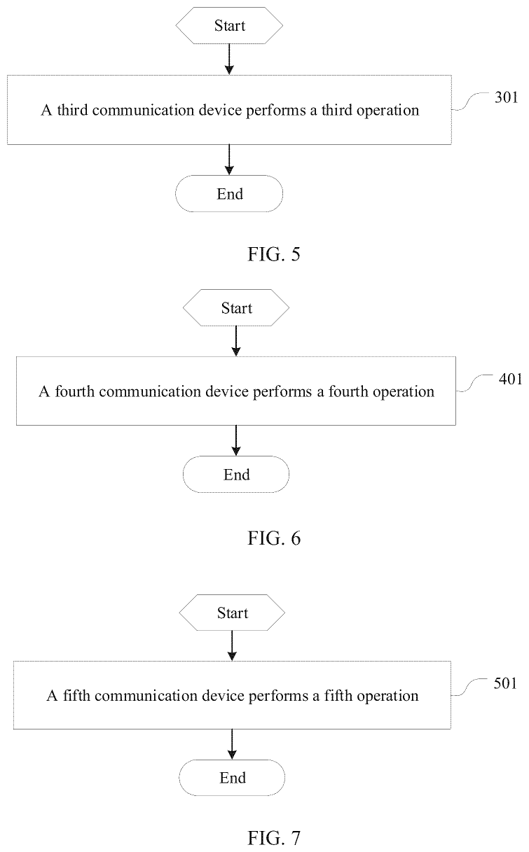

Refer to FIG. 5. An embodiment of this application provides an information determining method, which is applied to a third communication device. The third communication device includes, but is not limited to, a CN network element (such as one of the following: an SMF and an AMF) or a RAN network element, and the method includes the following steps.

Step 301: The third communication device performs a third operation.

The performing a third operation includes at least one of the following:
performing a first sub-operation of the third operation, including at least one of the following: configuring a first monitoring configuration; configuring a second monitoring configuration; configuring first assistance information; configuring second assistance information; configuring a first requirement; sending at least one of the following to a third target end: the first monitoring configuration, the first requirement, and the first assistance information; and sending one of the following to a fourth target end: the second monitoring configuration and the second assistance information;
receiving at least one of first jitter information, third information, fifth information, and seventh information;
sending at least one of the first jitter information, the third information, the fifth information, and the seventh information;
determining the first jitter information based on the fifth information; and
determining at least one of the following based on the third information: a data packet transmission time interval, a data periodicity, a target burst to which the target data packet belongs, a boundary of the target burst, and a first feature;
where
the first monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
the second monitoring configuration is used for requesting to monitor a second delay, and the second delay is a delay (for example, a downlink delay) between an anchor user plane function (UPF) network element and a RAN network element; or, the second monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter; and
the first assistance information includes at least one of the following: a sampling frequency, a first feature, a data periodicity, a first time interval threshold, a second time interval threshold, and a third time interval threshold;
the second assistance information includes at least one of the following: a sampling frequency, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay;
the first requirement is used for requesting to send a first timestamp to a second communication device;
the first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element; and
the third time is a time at which the target data packet arrives at a first communication device;
where
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range;
where
the seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

In an implementation, the third communication device includes one of the following: an SMF, an AMF, and a RAN network element.

In an implementation, the third target end includes one of the following: a UPF (such as a PSA) and a terminal. When the third target end is a terminal, the third communication device includes one of the following: an SMF, an AMF, and a RAN network element. When the third target end is a UPF, the third communication device includes: an SMF.

In an implementation, the fourth target end includes a RAN.

Optionally, the target data packet is one of the following: the 1st data packet in the target burst.

In an implementation, the 1st data packet of the target burst includes a data packet that first arrives in the target burst.

For downlink, a data packet first arriving in the target burst represents a data packet first arriving at the second communication device (such as the RAN network element) in the target burst.

For uplink, a data packet first arriving in the target burst represents a data packet that first arrives at the first communication device (such as the terminal (such as the AS or NAS of the terminal)) in the target burst, such as a data packet arriving at the AS of the terminal and waiting to be sent.

Optionally, the receiving first jitter information, fifth information, and/or seventh information includes: receiving the first jitter information, the fifth information, and/or the seventh information from the first communication device; and
the sending of the first jitter information, the fifth information, and/or the seventh information includes at least one of the following:
sending the first jitter information, the fifth information, and/or the seventh information to a fourth communication device; and
sending the first jitter information to the second communication device.

In an implementation, the fourth communication device includes a PCF.

In an implementation, the second communication device includes a RAN.

Optionally, the method further includes:
receiving, by the third communication device, a first monitoring requirement, a second requirement, and/or third assistance information; and
performing a first sub-operation of the third operation according to the first monitoring requirement, the second requirement, and/or the third assistance information.

In an implementation, the third communication device receives a first monitoring requirement sent by the fourth communication device (for example, a PCF) and/or a second requirement.

Optionally, the method further includes:
performing at least one of the following based on the seventh information: configuring the first assistance information; and configuring the second assistance information.

Optionally, the determining at least one of the following: a data packet transmission time interval, a data periodicity, a target burst to which the target data packet belongs, a boundary of the target burst, and a first feature includes:
determining at least one of the following based on the third information: a data packet transmission time interval, a data periodicity, a target burst to which the target data packet belongs, a boundary of the target burst, and a first feature.

The third information includes:
a first timestamp, a first time, a second time, and/or a third time of one or more target data packets.

The plurality is greater than or equal to two.

Optionally, the one or more target data packets are the 1st data packets of one or more target bursts.

Optionally, the determining the first jitter information includes:
determining the first jitter information based on the fifth information; and
the fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

Optionally, the determining the first jitter information based on the fifth information includes one of the following:
determining the first jitter based on one of the following: a second time of the 1st data packet in the target burst and a start time of the target burst; and a third time of the 1st data packet in the target burst and a start time of the target burst;
collecting statistics about one or more first jitters, and determining at least one of the following based on a statistical result of the first jitter: a first jitter range, a first duration, and an adjusted start time of the target burst;
collecting statistics about one or more first delays, and determining at least one of the following based on a statistical result of the first delay: a first jitter range, and a start time of the target burst; and
collecting statistics about one or more first intervals, and determining at least one of the following based on a statistical result of the first interval: a first jitter range, a first duration, and an adjusted start time of the target burst.

The first interval is one of the following: a time difference between the second time of the 1st data packet in the target burst and the start time of the target burst, and a time difference between the second time of the 1st data packet in the target burst and the start time of the target burst;
the first duration is used for adjusting a predicted start time of the target burst; and
the adjusted start time of the target burst is a start time of the target burst before adjustment plus the first duration.

In the embodiments of this application, the first operation is performed so as to support determining a data transmission interval and/or a no data transmission interval, so that the terminal can sleep in the no data transmission interval, implementing energy-saving for the terminal.

Refer to FIG. 6. An embodiment of this application provides an information determining method, which is applied to a fourth communication device. The fourth communication device includes but is not limited to a CN network element (such as a PCF), and the method includes the following steps.

Step 401: The fourth communication device performs a fourth operation.

The fourth operation includes at least one of the following:
performing a first sub-operation of the fourth operation;
sending at least one of the following to a fourth target end: a first monitoring requirement, a second requirement, and third assistance information;
receiving at least one of first jitter information, third information, fifth information, and seventh information;
determining the first jitter information based on the fifth information; and
determining at least one of the following based on the third information: a data packet transmission time interval, a data periodicity, a target burst to which the target data packet belongs, a boundary of the target burst, and a first feature.

The first sub-operation of the fourth operation includes at least one of the following:
configuring a first monitoring requirement, where the first monitoring requirement is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
configuring third assistance information, where the third assistance information includes at least one of the following: a sampling frequency, a first feature, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay; and
configuring a second requirement, where the second requirement is used for requesting to send a first timestamp to a second communication device.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element; and
the third time is a time at which the target data packet arrives at a first communication device;
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst;
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

The seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

In an implementation, the fourth communication device includes a PCF.

In an implementation, the fourth communication device sends the first monitoring requirement and/or the second requirement to the third communication device.

In an implementation, the fourth communication device receives the first delay sent by the UPF or the SMF.

In an implementation, the fourth communication device determines the first jitter information based on the received first delay.

In an implementation, the fourth target end is an SMF or a UPF.

Optionally, the target data packet is one of the following: the 1st data packet in the target burst.

In an implementation, the 1st data packet of the target burst includes a data packet that first arrives in the target burst.

For downlink, a data packet first arriving in the target burst represents a data packet first arriving at the second communication device (such as the RAN network element) in the target burst.

For uplink, a data packet first arriving in the target burst represents a data packet that first arrives at the first communication device (such as the terminal (such as the AS or NAS of the terminal)) in the target burst, such as a data packet arriving at the AS of the terminal and waiting to be sent.

Optionally, the receiving at least one of first jitter information, third information, fifth information, and seventh information includes:
receiving at least one of the first jitter information, the third information, the fifth information and the seventh information from the fourth target end or a fifth target end.

In an implementation, the fourth target end includes a third communication device (such as an SMF)

In an implementation, the fifth target end includes a first communication device (such as a UPF or a terminal).

Optionally, the determining the first jitter information based on the fifth information includes one of the following:
determining the first jitter based on one of the following: a second time of the 1st data packet in the target burst and a start time of the target burst; and a third time of the 1st data packet in the target burst and a start time of the target burst;
collecting statistics about one or more first jitters, and determining at least one of the following based on a statistical result of the first jitter: a first jitter range, a first duration, and an adjusted start time of the target burst;
collecting statistics about one or more first delays, and determining at least one of the following based on a statistical result of the first delay: a first jitter range, and a start time of the target burst; and
collecting statistics about one or more first intervals, and determining at least one of the following based on a statistical result of the first interval: a first jitter range, a first duration, and an adjusted start time of the target burst.

The first interval is one of the following: a time difference between the second time of the 1st data packet in the target burst and the start time of the target burst, and a time difference between the second time of the 1st data packet in the target burst and the start time of the target burst;
the first duration is used for adjusting a predicted start time of the target burst;
the adjusted start time of the target burst is a start time of the target burst before adjustment plus the first duration; and
the first duration is a positive value or a negative value.

Optionally, the method further includes:
receiving, by a fourth communication device, ninth information; and
performing a first sub-operation of a fourth operation based on the ninth information.

The ninth information includes at least one of the following:
a sampling frequency;
a first feature;
a first time interval threshold;
a second time interval threshold; and
a third time interval threshold.

Optionally, the configuring third assistance information includes:
configuring the third assistance information based on the seventh information.

Optionally, the determining at least one of the following: a data packet transmission time interval, a data periodicity, a target burst to which the target data packet belongs, a boundary of the target burst, and a first feature includes:
determining at least one of the following based on the third information: a data packet transmission time interval, a data periodicity, a target burst to which the target data packet belongs, a boundary of the target burst, and a first feature.

The third information includes:
a first timestamp, a first time, a second time, and/or a third time of one or more target data packets.

The plurality is greater than or equal to two.

Optionally, the one or more target data packets are the 1st data packets of one or more target bursts.

In the embodiments of this application, the first operation is performed so as to support determining a data transmission interval and/or a no data transmission interval, so that the terminal can sleep in the no data transmission interval, implementing energy-saving for the terminal.

Refer to FIG. 7. An embodiment of this application provides an information determining method, which is applied to a fifth communication device. The fifth communication device includes, but is not limited to, a CN network element (such as an AF or a network equipment function (Network Equipment Functions, NEF)), and the method includes the following steps.

Step 501: The fifth communication device performs a fifth operation.

The fifth operation includes at least one of the following:
sending ninth information, where the ninth information includes at least one of the following:
a sampling frequency;
a first feature;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

Optionally, the ninth information further includes a data periodicity.

In this embodiment of this application, determining a data transmission interval and/or a no data transmission interval can be supported, so that the terminal can sleep in the no data transmission interval, implementing energy-saving for the terminal.

The following describes an embodiment of this application using application scenarios.

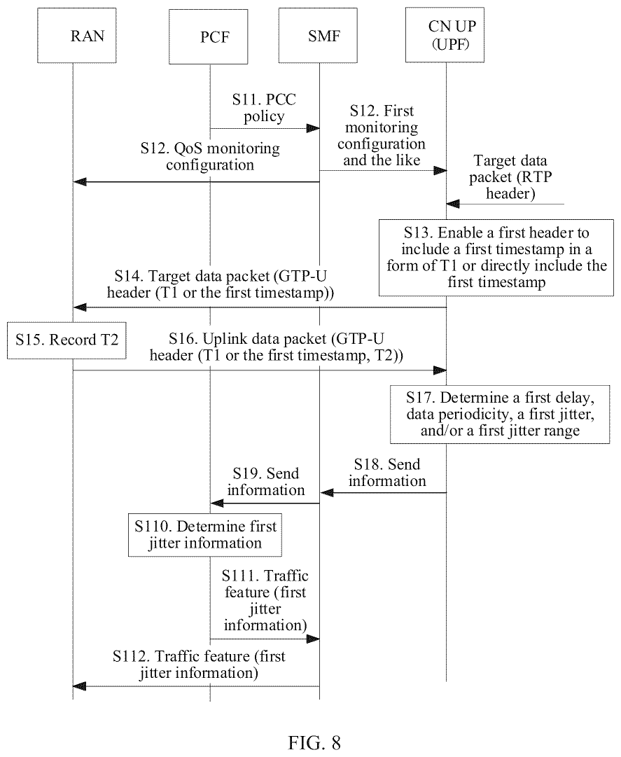

Application scenario 1 of the embodiments of this application mainly describes a process in which the UPF (such as the CN uploads (UP)) determines a first delay or a first jitter and the PCF determines a first jitter range; or the UPF directly determines a first delay range. Referring to FIG. 8, the following steps are included:

Step S11: The PCF sends a policy and charging control (PCC) policy to the SMF.

The PCC policy may carry at least one of the following: a first monitoring requirement, a second requirement, and third assistance information.

It should be noted that for related descriptions of the first monitoring requirement, the second requirement, and the third assistance information, reference may be made to the method embodiment shown in FIG. 2, and details are not repeated here.

Step S12: The SMF may perform a first sub-operation of a third operation based on the first monitoring requirement, the second requirement, and the third assistance information, including at least one of the following: configuring a first monitoring configuration; configuring a second monitoring configuration; configuring first assistance information; configuring second assistance information; and configuring a first requirement.

The SMF sends at least one of the following to the UPF: the first monitoring configuration, the first requirement, and the first assistance information.

The SMF sends at least one of the following to the RAN: the second monitoring configuration and the second assistance information.

Step S13: Based on the first monitoring configuration, the first requirement, and/or the first assistance information, the UPF performs a first operation, as shown in the embodiment of FIG. 3.

For example, a first sub-operation of the first operation includes:
determining a time corresponding to the first timestamp;
sending the first timestamp or the time corresponding to the first timestamp as the first time; and
enabling a GTP-U header of the target data packet to include at least one of the following: information for identifying the target data packet (such as a sequence number of the target data packet), a first timestamp, and a first time T1.

In an implementation, the target data packet is a downlink data packet, and an RTP header of the target data packet includes a first timestamp. The UPF receives the target data packet, and converts the timestamp in the RTP header into T1 or copies it into the first header for sending.

It should be noted that the server adds a timestamp to each RTP packet.

T1 may be a timestamp carried by each downlink data packet, or may be a timestamp carried by the 1st data packet of a target burst to which the target data packet belongs.

Step S14: The UPF sends a target data packet to the RAN, where the target data packet carries a GTP-U header, and the GTP-U header carries T1 or a first timestamp.

Step S15: The RAN records a second time T2, where T2 is a time at which the RAN network element receives the target data packet.

Step S16: The RAN sends an uplink data packet to the UPF, where the uplink data packet includes a GTP-U header, and the GTP-U header includes T1 and T2.

Step S17: The UPF performs a second sub-operation of the first operation based on T1, the first timestamp, and/or T2; as described in the embodiment of the first communication device of FIG. 3.

For example, the second sub-operation of the first operation includes determining a data periodicity, a first delay, a first jitter, and/or a first jitter range;
where
the UPF may calculate T2−T1, and determine a time difference between T2 and T1 as the first delay, where the first delay may be a downlink delay between the server and the RAN.

Alternatively, the UPF may determine one of the following based on the first timestamp: the 1st data packet in the target burst, and a start time of the target burst. The UPF may further determine the first jitter based on the second time T2 of the 1st data packet in the target burst and the start time of the target burst.

Step S18: The UPF sends third information, fifth information, seventh information (such as a data periodicity, a first delay, and/or a first jitter), or a first jitter range to the SMF.

Step S19: The SMF sends the third information, the fifth information, the seventh information (such as the data periodicity, the first delay, and/or the first jitter) or the first jitter range to the PCF.

Step S110: The PCF determines first jitter information based on the fifth information or the first jitter.

The PCF may determine a data periodicity based on the third information.

The UE may collect statistics about a plurality of first delays, determine a jitter range based on a statistical result of the first delay, and use the jitter range as the first jitter information.

The PCF may collect statistics about a plurality of first jitters, determine a jitter range based on a statistical result of the first jitter, and use the jitter range as the first jitter information.

Step S111: The PCF sends a traffic feature to the SMF, where the traffic feature carries the first jitter information or the first jitter range.

Step S112: The SMF sends the traffic feature to the RAN.

It should be noted that in the technology of QoS monitoring, the RAN supports recording a packet receiving time T2 for a received data packet. At present, the RAN supports transferring T2 to the UPF through an uplink packet.

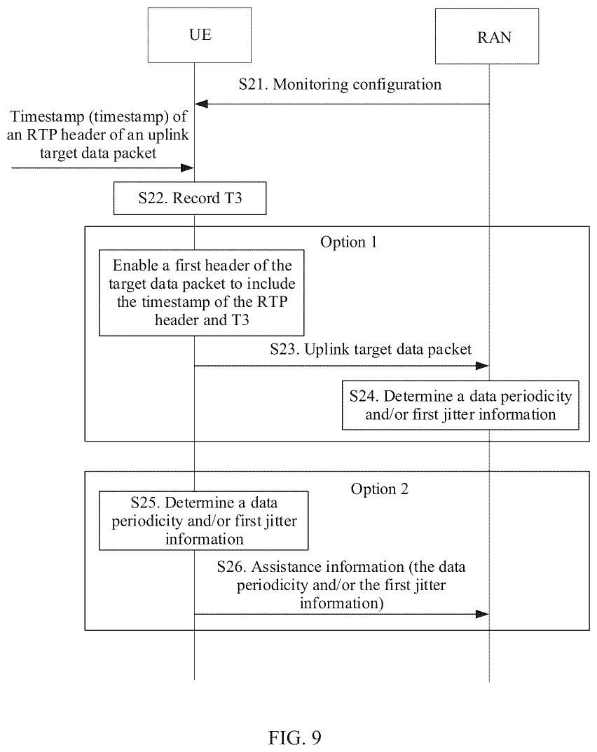

Application scenario 2 of the embodiments of this application mainly describes the process of determining the first delay or the first jitter by the terminal, determining the first jitter range by the RAN, or directly determining the first jitter range by the terminal. Referring to FIG. 9, the following steps are included:

Step S21: The RAN may perform a first sub-operation of a third operation, including at least one of the following: configuring a first monitoring configuration; and configuring first assistance information.

The RAN sends at least one of the following to the UE: the first monitoring configuration and the first assistance information;

Step S22: Based on the first monitoring configuration and/or the first assistance information, the UE performs a first operation, as described in the embodiment of FIG. 3.

For example, the first operation includes at least one of the following:
recording a third time T3, where T3 is a time of receiving the target data packet by the UE (such as the AS or the NAS of the UE);
assigning, to a target data packet, information for identifying the target data packet;
assigning, to a target burst, information for identifying the target burst;
enabling a first header of the target data packet to include at least one of the following: information for identifying the target data packet and information for identifying the target burst to which the target data packet belongs;
enabling a first header of the 1st data packet in the target burst to include a start indication of the target burst;
enabling a first header of the last data packet in the target burst to include an end indication of the target burst;
determining a first delay;
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst;
determining first jitter information;
enabling the first header (such as a SDAP header, a PDCP header, an RLC header, and a MAC header) of the target data packet to include at least one of the following: information for identifying the target data packet, information for identifying the target burst to which the target data packet belongs, a third time T3, and a first timestamp; and
sending the target data packet to the RAN.

In an implementation, the target data packet is an uplink data packet, and the RTP header of the target data packet includes a first timestamp. The UE receives the target data packet and copies the timestamp in the RTP header into the first header.

It should be noted that the server adds a timestamp to each RTP packet.

Based on the first timestamp and/or T3, the UE may determine a data periodicity, and determine a first delay, determine a first jitter, and/or a first jitter interval;
where
the UE may calculate the first delay based on a difference between T3 and a time corresponding to the first timestamp;
or,
the UE may determine one of the following based on the first timestamp: the 1st data packet in the target burst, and a start time of the target burst. The UE may further determine the first jitter based on the third time T3 of the 1st data packet in the target burst and the start time of the target burst.

The UE may determine the range of the first jitter based on a statistical result of the first jitter.

The UE sends the target data packet and/or sends assistance information to the RAN.

The assistance information includes one of the following: the first information, third information, fifth information, and seventh information. For example, the assistance information may include at least one of the following: a data periodicity, a jitter range, a first jitter, and a first delay.

Contents contained in the first header of the target data packet are described in S11, and details are not described here.

The RAN may directly receive a data periodicity and a first jitter range from the terminal.

The RAN may determine the first jitter information based on the fifth information or the first jitter.

The RAN may determine the data periodicity based on the third information.

The RAN may determine the data periodicity, the first delay, the first jitter and/or the first jitter range based on the first timestamp and/or T3.

Option 1 is steps S23 and S24.

Step S23: The UE sends the target data packet to the RAN. Contents contained in the first header of the target data packet are described in S11, and details are not described here.

In step S24, the RAN may determine the data periodicity, the first delay, the first jitter and/or the first jitter range based on the first timestamp and/or T3.

Option 2 is steps S25 and S26.

S25: The RAN may determine the data periodicity, the first delay, the first jitter and/or the first jitter range based on the first timestamp and/or T3.

S26: The UE sends assistance information to the RAN. The assistance information includes the data periodicity and the first jitter information (such as a jitter range). The RAN directly receives the data periodicity and the first jitter range from the terminal.

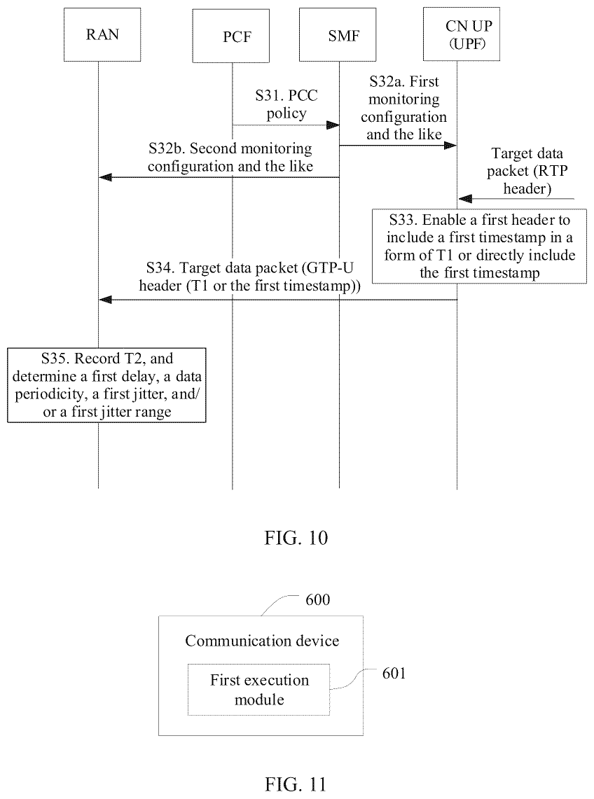

Application scenario 3 of the embodiments of this application mainly describes the process of determining the first jitter information by the RAN. Referring to FIG. 10, the procedure includes the following steps.

Step S31: As described in step 32, details are not repeated here.

Step S32: The SMF may perform a first sub-operation of a third operation based on the first monitoring requirement, the second requirement, and the third assistance information, including at least one of the following: configuring a first monitoring configuration; configuring a second monitoring configuration; configuring first assistance information; configuring second assistance information; and configuring a first requirement.

The SMF sends at least one of the following to the UPF: the first monitoring configuration, the first requirement, and/or the first assistance information.

The SMF sends at least one of the following to the RAN: the second monitoring configuration and the second assistance information.

Step S33: Based on the first monitoring configuration, the first requirement, and/or the first assistance information, the UPF performs a first operation, as shown in the embodiment of FIG. 3.

For example, a first sub-operation of the first operation includes:
determining a time corresponding to the first timestamp;
sending the first timestamp or the time corresponding to the first timestamp as the first time; and
enabling a GTP-U header of the target data packet to include at least one of the following: a first timestamp, and a first time T1.

In an implementation, the target data packet is a downlink data packet, and an RTP header of the target data packet includes a first timestamp. The UPF receives the target data packet, and converts the timestamp in the RTP header into T1 or copies it into the first header for sending.

T1 may be a timestamp carried by each downlink data packet, or may be a timestamp carried by the 1st packet of a burst.

Step S34: The UPF sends a target data packet to the RAN, where the target data packet carries a GTP-U header, and the GTP-U header carries T1 or a first timestamp.

Step S35: The RAN records a second time T2 and determines first jitter information.

T2 is a time at which the RAN network element receives the target data packet.

The first jitter information may include a jitter range of the first delay or a delay difference of the first delay.

The RAN can calculate T2−T1, and determine a time difference between T2 and T1 as the first delay, where the first delay is a downlink delay between the server and the RAN. The RAN may collect statistics about a plurality of first delays, determine a first jitter range based on a statistical result of the first time, and use the first jitter range as the first jitter information.

The RAN performs a second sub-operation of the first operation based on T1, the first timestamp, and/or T2; as described in the embodiment of the first communication device of FIG. 3.

For example, the second sub-operation of the first operation includes determining a data periodicity, a first delay, a first jitter, and/or a first jitter range;

Refer to FIG. 11. FIG. 11 is a schematic structural diagram of a communication device according to an embodiment of this application. The communication device is a first communication device. As shown in FIG. 11, the communication device 600 includes:
a first execution module 601, configured to perform a first operation.

The performing a first operation includes at least one of the following:
obtaining first information, where the first information includes at least one of the following: a first timestamp of a target data packet, a sampling frequency, information for identifying the target data packet, and information for identifying a target burst to which the target data packet belongs;
performing a first sub-operation of the first operation based on the first information; and
performing a second sub-operation of the first operation;
where
the second sub-operation of the first operation includes at least one of the following:
determining a third time;
assigning, to a target data packet, information for identifying the target data packet;
assigning, to a target burst, information for identifying the target burst;
enabling a first header of the target data packet to include at least one of the following: information for identifying the target data packet and information for identifying the target burst to which the target data packet belongs;
enabling a first header of the 1st data packet in the target burst to include a start indication of the target burst;
enabling a first header of the last data packet in the target burst to include an end indication of the target burst;
determining a first delay, where the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first sub-operation of the first operation includes at least one of the following:
enabling the first header of the target data packet to include at least one of the following: information for identifying the target data packet (such as a sequence number of the target data packet), information for identifying the target burst to which the target data packet belongs (such as a sequence number of the target burst), the first timestamp, and a first time;
determining a time corresponding to the first timestamp;
sending the first timestamp or the time corresponding to the first timestamp as the first time;
sending the target data packet to a first target end;
sending assistance information to the first target end, where the assistance information includes at least one of the following: the first information, third information, fifth information, and seventh information; and
receiving a first data packet after the target data packet is sent to the first target end, where a first header of the first data packet includes one of the following: information for identifying the target data packet, the first timestamp, the first time, and a second time.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs; and
the first source end is a data source end of the target data packet;
where
the first time is in a form of a time of sending the target data packet by the first communication device;
the second time is a time at which the target data packet arrives at the second communication device or the RAN network element; and
the third time is a time at which the target data packet arrives at a first communication device (such as an AS of the terminal).

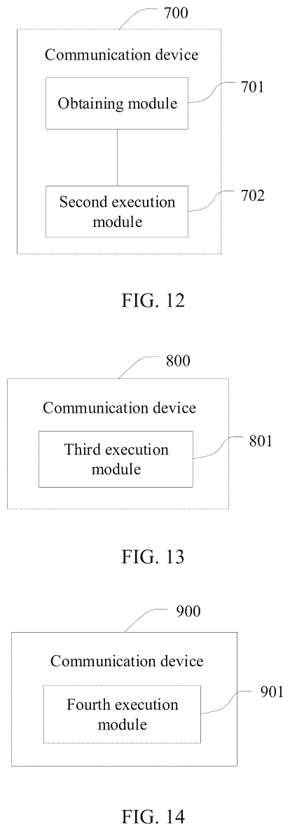

Refer to FIG. 12. FIG. 12 is a schematic structural diagram of a communication device according to an embodiment of this application. The communication device is a second communication device. As shown in FIG. 12, the communication device 700 includes:
an obtaining module 701, configured to obtain eighth information, where the eighth information includes at least one of the following: a first timestamp of a target data packet, a sampling frequency, information for identifying the target data packet, information for identifying a target burst to which the target data packet belongs, a second time of the target data packet, and a third time of the target data packet; and
a second execution module 702, configured to execute a second operation based on the eighth information.

The second operation includes at least one of the following:
determining a time corresponding to the first timestamp;
determining a first delay, where the first delay is one of the following: a required delay for a target data packet to pass between the first source end and a radio access network RAN network element, a time difference between a sampling time of the 1st byte of the target data packet and a time at which the target data packet arrives at a second communication device (such as a RAN network element), and a time difference between the sampling time of the 1st byte of the target data packet and a time at which the target data packet arrives at a first communication device (for example, a time of arriving at an AS or NAS of a terminal and starting to wait for transmission);
determining at least one of the following: a data packet transmission time interval, a data periodicity, the target burst to which the target data packet belongs, a boundary of the target burst, and a first feature; where the first feature is used to indicate one of the following: a data flow transmission has a periodic feature, and a data flow transmission has no periodic feature;
determining related information of the target burst, where the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
determining first jitter information.

The first timestamp is used to indicate one of the following: a packet sending time of the target data packet sent by the first source end and the sampling time of the 1st byte of the target data packet; and/or the first timestamp is a timestamp in a first header of the target data packet or a first timestamp in a form of a first time;
the first source end is a data source end of the target data packet;
the second time is a time at which the target data packet arrives at the second communication device or the RAN network element; and
the third time is one of the following: a time at which the target data packet arrives at the first communication device (for example, the AS or NAS of the terminal).

Refer to FIG. 13. FIG. 13 is a schematic structural diagram of a communication device according to an embodiment of this application. The communication device is a third communication device. As shown in FIG. 13, the communication device 800 includes:
a third execution module 801, configured to perform a third operation.

The performing a third operation includes at least one of the following:
performing a first sub-operation of the third operation, including at least one of the following: configuring a first monitoring configuration; configuring a second monitoring configuration; configuring first assistance information; configuring second assistance information; configuring a first requirement; sending at least one of the following to a third target end: the first monitoring configuration, the first requirement, and the first assistance information; and sending one of the following to a fourth target end: the second monitoring configuration and the second assistance information;
receiving at least one of first jitter information, third information, fifth information, and seventh information;
sending at least one of the first jitter information, the third information, the fifth information, and the seventh information;
determining the first jitter information based on the fifth information; and
determining at least one of the following based on the third information: a data packet transmission time interval, a data periodicity, a target burst to which the target data packet belongs, a boundary of the target burst, and a first feature;
where
the first monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
the second monitoring configuration is used for requesting to monitor a second delay, and the second delay is a delay (for example, a downlink delay) between an anchor user plane function UPF network element and a RAN network element; or, the second monitoring configuration is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter; and
the first assistance information includes at least one of the following: a sampling frequency, a first feature, a data periodicity, a first time interval threshold, a second time interval threshold, and a third time interval threshold;
the second assistance information includes at least one of the following: a sampling frequency, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay;
the first requirement is used for requesting to send a first timestamp to a second communication device;
the first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element; and
the third time is a time at which the target data packet arrives at a first communication device;
where
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst; and
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range;
where
the seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

Refer to FIG. 14. FIG. 14 is a schematic structural diagram of a communication device according to an embodiment of this application. The communication device is a fourth communication device. As shown in FIG. 14, the communication device 900 includes:
a fourth execution module 901, configured to perform a fourth operation, where
the fourth operation includes at least one of the following:
performing a first sub-operation of the fourth operation;
sending at least one of the following to a fourth target end: a first monitoring requirement, a second requirement, and third assistance information;
receiving at least one of first jitter information, third information, fifth information, and seventh information;
determining the first jitter information based on the fifth information; and
determining at least one of the following based on the third information: a data packet transmission time interval, a data periodicity, a target burst to which the target data packet belongs, a boundary of the target burst, and a first feature.

The first sub-operation of the fourth operation includes at least one of the following:
configuring a first monitoring requirement, where the first monitoring requirement is used for requesting to monitor at least one of the following: a first timestamp, a second time, and/or a third time of a target data packet; a first delay; a data packet transmission time interval; a data periodicity; a target burst to which the target data packet belongs; a boundary of the target burst; whether data flow transmission has a periodic feature; related information of the target burst; first jitter information; a first jitter range; and a first jitter;
configuring third assistance information, where the third assistance information includes at least one of the following: a sampling frequency, a first feature, a data periodicity, a first time interval threshold, a second time interval threshold, a third time interval threshold, a data packet transmission time interval, a target burst to which the target data packet belongs, a boundary of the target burst, a first feature, related information of the target burst, first jitter information, and a first delay; and
configuring a second requirement, where the second requirement is used for requesting to send a first timestamp to a second communication device.

The first timestamp is used to indicate one of the following: a packet sending time of the target data packet sent by the first source end and the sampling time of the 1st byte of the target data packet; and/or the first timestamp is one of the following: a timestamp in a second header of the target data packet and a timestamp of the 1st data packet (which is, for example, first sent) in the target burst to which the target data packet belongs;
the second time is a time at which the target data packet arrives at the second communication device or the RAN network element; and
the third time is a time at which the target data packet arrives at a first communication device;
the related information of the target burst includes at least one of the following: a start time of the target burst, the 1st data packet in the target burst, an arrival time of the 1st data packet in the target burst, a time at which the 1st data packet in the target burst arrives at the second communication device (such as a time of arriving at the RAN network element), a time at which the 1st data packet in the target burst arrives at the first communication device (such as a time of arriving at the terminal), an end time of the target burst, the last data packet in the target burst, and a data packet included in the target burst;
the first delay is one of the following: a required delay for a target data packet to pass between the first source end and the second communication device (such as a RAN network element), a time difference between a sampling time of the 1st byte of the target data packet and a time at which the target data packet arrives at a second communication device (such as the RAN network element), and a time difference between the sampling time of the 1st byte of the target data packet and a time at which the target data packet arrives at a first communication device (for example, a time of arriving at an AS or NAS of a terminal and starting to wait for transmission);
the first source end is a data source end of the target data packet;
the first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

The third information includes:
a first timestamp, a first time, a second time, and/or a third time of one or more target data packets.

The fifth information includes at least one of the following:
a first delay of one or more target data packets;
a first jitter of one or more target data packets; and
a first timestamp, a first time, a second time, and/or a third time of one or more target data packets; where
a start time of one or more target bursts;
a second time of the 1st data packet in one or more target bursts, where the 1st data packet in the target burst is a data packet that first arrives at the second communication device in the target burst;
a third time of the 1st data packet in one or more target bursts, where the 1st data packet in the target burst is a data packet that first arrives at the first communication device in the target burst;
a first timestamp of the 1st data packet in one or more target bursts; and/or
the first jitter information including a first jitter and/or a first jitter range.

The seventh information includes at least one of the following: the first timestamp of the target data packet, the sampling frequency, the information for identifying the target data packet, the information for identifying the target burst to which the target data packet belongs, the second time of the target data packet, the third time of the target data packet, the first delay, the data packet transmission time interval, the data periodicity, the target burst to which the target data packet belongs, the boundary of the target burst, the first feature, related information of the target burst, the first jitter range, and the first jitter.

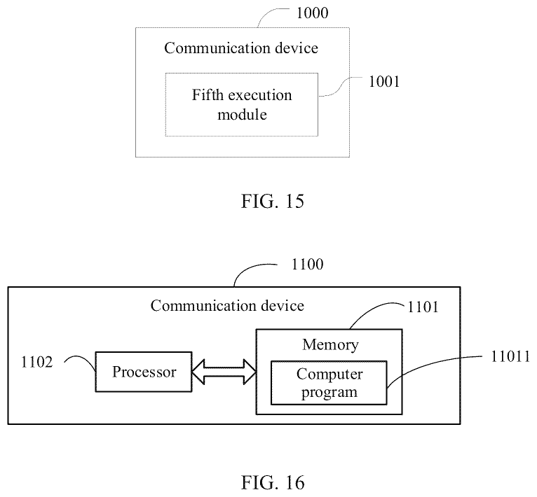

Refer to FIG. 15. FIG. 15 is a schematic structural diagram of a communication device according to an embodiment of this application. The communication device is a fifth communication device. As shown in FIG. 15, the communication device 1000 includes:
a fifth execution module 1001, configured to perform a fifth operation, where
the fifth operation includes at least one of the following:
sending ninth information, where the ninth information includes at least one of the following:
a sampling frequency;
a first feature;
a first time interval threshold;
a second time interval threshold; and
a third time interval threshold.

The first time interval threshold is one of the following: a minimum time interval between a sending time of the last data packet in a previous target burst and a sending time of a target data packet in a next target burst in two consecutive different target bursts, and a minimum time interval between an arrival time of the last data packet in the previous target burst and an arrival time of the target data packet in the next target burst in two consecutive different target bursts;
the second time interval threshold is one of the following: a maximum time interval between sending times of data packets in one target burst and a sending time of the 1st data packet in the target burst, and a maximum time interval between arrival times of data packets in one target burst and an arrival time of the 1st data packet in the target burst; and
the third time interval threshold is one of the following: a maximum time interval between sending times of two consecutive data packets in one target burst, and a maximum time interval between arrival times of two consecutive data packets in one target burst.

Optionally, as shown in FIG. 16, an embodiment of this application further provides a communication device 1100, including a processor 1102, a memory 1101, and a computer program 11011 stored in the memory 1101 and capable of running on the processor 1102. When the computer program 11011 is executed by the processor 1102, the processes of the foregoing embodiments of the information determining method are implemented, with the same technical effects achieved. To avoid repetition, details are not described herein again.

An embodiment of this application further provides a computer-readable storage medium, where a computer program is stored in the computer-readable storage medium. When the computer program is executed by a processor, the processes of the foregoing embodiments of the information determining method are implemented, with the same technical effects achieved. To avoid repetition, details are not described herein again. For example, the computer-readable storage medium is a read-only memory (ROM), a random access memory (RAM), a magnetic disk, an optical disc, or the like.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element.

By means of the foregoing description of the implementations, persons skilled in the art may clearly understand that the method in the foregoing embodiment may be implemented by software with a necessary general hardware platform. Certainly, the method in the foregoing embodiment may also be implemented by hardware. However, in many cases, the former is a preferred implementation. Based on such an understanding, the technical solutions of this application essentially or the part contributing to the related art may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

1. An information determining method, comprising:
receiving, by a first communication device, from a third communication device, a first monitoring configuration; wherein the first monitoring configuration is used for requesting to monitor first jitter information; and
performing, by the first communication device, a first operation; wherein
the performing a first operation comprises:
determining first jitter information; wherein the first jitter information is jitter information associated with a data periodicity.

2. The method according to claim 1, wherein a value of the first jitter information comprises a time difference between an arrive time of a target data packet of a target burst first arriving at the first communication device and a start time of the target burst.

3. The method according to claim 2, wherein the start time of the target burst is inferred based on the data periodicity.

4. The method according to claim 1, wherein the first monitoring configuration is further used for requesting to monitor the data periodicity;
Wherein the performing a first operation further comprises: determining the data periodicity.

5. The method according to claim 1, wherein before the performing, by a first communication device, a first operation, the method further comprises:
receiving, by the first communication device, from the third communication device, first assistance information, wherein the first assistance information comprises: the data periodicity.

6. The method according to claim 1, wherein after the performing, by a first communication device, a first operation, the method further comprises:
sending, by the first communication device, to the third communication device, the first jitter information.

7. The method according to claim 1, wherein the data periodicity is a data periodicity in the downlink direction or a data periodicity in the uplink direction.

8. The method according to claim 1, wherein the first communication device comprises a User Plane Function (UPF), and the third communication device comprises a Session Management Function (SMF).

9. An information determining method, comprising:
sending, by a third communication device, to a first communication device, first monitoring configuration;
wherein the first monitoring configuration is used for requesting to monitor first jitter information; wherein the first monitoring information is jitter information associated with a data periodicity.

10. The method according to claim 9, wherein the first monitoring configuration is further used for requesting to monitor the data periodicity.

11. The method according to claim 9, further comprising:
sending, by the third communication device, to the first communication device, first assistance information;
wherein the first assistance information comprises the data periodicity.

12. The method according to claim 9, wherein the data periodicity is a data periodicity in the downlink direction or a data periodicity in the uplink direction.

13. The method according to claim 9, further comprising:
receiving, by the third communication device, the first jitter information from the first communication device.

14. The method according to claim 13, further comprising:
sending, by the third communication device, the first jitter information to a radio access network RAN network element.

15. The method according to claim 9, wherein the method further comprises:
receiving, by the third communication device, from a fourth communication device, a first monitoring requirement, and/or third assistance information;
wherein the third assistance information comprises a data periodicity;
wherein the first monitoring requirement is used for requesting to monitor the first jitter information.

16. The method according to claim 15, wherein the first monitoring requirement is further used for requesting to monitor the data periodicity.

17. The method according to claim 9, wherein the first communication device comprises a User Plane Function (UPF), and the third communication device comprises a Session Management Function (SMF).

18. An information determining method, comprising:
sending, by a fourth communication device, at least one of the following to a third communication device: a first monitoring requirement, or third assistance information;
wherein the first monitoring requirement is used for requesting to monitor first jitter information;
wherein the third assistance information comprises a data periodicity.

19. The method according to claim 18, wherein the first monitoring requirement is further used for requesting to monitor the data periodicity.

20. The method according to claim 18, wherein the third communication device comprises a Session Management Function (SMF), and the fourth communication device comprises a user plane function (UPF).
